(19) United States
(12) Patent Application Publication
(10) Pub. No.: US 2026/0165489 A1
(43) Pub. Date: Jun. 18, 2026

(54) Modular Furniture Systems

(71) Applicant: The Lovesac Company, Stamford, CT (US)

(72) Inventors: Shawn D. Nelson, Washington, UT (US); David M. Underwood, Hurricane, UT (US); Casey Lee Webb, Washington, UT (US); Jonathan Baker, St. George, UT (US); Jacob D. Forman, Washington City, UT (US); Stephen Ciccarelli, St. George, UT (US); Ryan J. Graham, St. George, UT (US); Joel H. Bennett, Morgan, UT (US); Tyler Sanders, St. George, UT (US); Manny Carreón, Hurricane, UT (US)

(21) Appl. No.: 19/087,036

(22) Filed: Mar. 21, 2025

Related U.S. Application Data
(63) Continuation-in-part of application No. 18/979,336, filed on Dec. 12, 2024.

(51) Int. Cl. A47C 17/02; A47C 15/00; A47C 17/86

(52) U.S. Cl. CPC A47C 17/02; A47C 15/002; A47C 17/86

(57) ABSTRACT

A modular furniture system comprising a front support, rear support, left support, right support, and an indexing foot. The front and rear support are configured to engage with pins that enable the left and right support to suspend from and be supported by the front and rear support. The indexing foot is configured to selectively couple with one or more of the front support, rear support, left support, and right support.

### CROSS-REFERENCE TO RELATED APPLICATIONS

This application is a continuation-in-part of U.S. application Ser. No. 18/979,336, filed on Dec. 12, 2024, entitled “Modular Furniture Systems,” which is hereby incorporated by reference in its entirety.

### BACKGROUND OF THE INVENTION

### 1. Technical Field

The present invention relates to modular furniture systems, and more particularly to modular furniture that is designed for ease of assembly, disassembly, and reconfiguration while maintaining structural stability and aesthetic versatility.

### 2. Background and Relevant Art

Modular furniture systems have gained popularity due to their versatility, adaptability, and ease of assembly. Such systems typically include components that can be configured, reconfigured, or expanded to suit various spatial and functional requirements. These systems are particularly advantageous for small living spaces, offices, or other environments where flexibility and efficient use of space are critical. Despite these benefits, existing modular furniture solutions often lack the ability to seamlessly combine robust structural stability with ease of customization and transportability.

There is a growing need for modular furniture systems that not only allow for quick assembly but also offer enhanced durability and aesthetic appeal. Additionally, many current designs require specialized tools or expertise to modify, making them less accessible to the average consumer. The present invention addresses these shortcomings by providing an improved modular furniture system that is both highly functional and user-friendly, enabling individuals to create customizable furniture layouts that are both stable and visually appealing.

### BRIEF SUMMARY OF THE INVENTION

Implementations of the present invention comprise systems, methods, shipping methods, and apparatus comprising modular furniture systems.

A modular furniture system can comprise: a rear support; a front support; a left support; a right support; a plurality of pins; and one or more indexing feet configured to selectively couple to at least one of the front support or the rear support; wherein the rear support, front support, left support, and right support are selectively coupled together by the plurality of pins in order to form a rectangular modular furniture system.

A modular furniture system can alternatively comprise: a rear support; a front support; a left support; a right support; a plurality of pins; one or more indexing feet, each of the one or more indexing feet configured to selectively couple to the left support and/or to the right support; wherein the rear support and front support are selectively suspended between the left support and right support by the plurality of pins in order to form a rectangular modular furniture system.

In another embodiment a modular furniture system can comprise: a rear support; a front support; a left support; a right support; a plurality of pins; and one or more indexing feet, each of the one or more indexing feet configured to selectively couple to the front support and/or to the rear support; wherein the left support and right support are selectively suspended from opposing ends of the rear support and front support by the plurality of pins in order to form a rectangular modular furniture system.

In one embodiment, each of the one or more indexing feet comprises a peg having a length and one or more spring detents.

In another embodiment, the front support has one or more rings pressed into a bottom surface, wherein a first ring is configured to receive a portion of a first peg of a first indexing foot of one the one or more indexing feet.

In yet another embodiment, a first spring detent of the one or more spring detents of the first peg engages with a first edge of the ring.

In a further embodiment, a second spring detent of one or more spring detents of the first peg engages with a first edge of the ring, and wherein the second spring detent is embedded into the first peg at a position farther along the length of the first peg relative to the support surface.

In another embodiment, a bracket is secured between the first indexing foot and the front support by the first peg.

In at least one embodiment, the modular furniture system further comprises a peg foot threadingly engaged with a foot adapter embedded into the bottom surface of the front support.

In another embodiment, the peg foot has a base that is received into a receiver defined by a support surface of the first indexing foot.

In yet another embodiment, the peg foot prevents the indexing foot from rotating about a horizontal axis of the first peg.

In another embodiment, the first indexing foot further comprises a support surface configured to abut a bottom surface of either the left support or a bottom surface of the right support.

In a further embodiment, the first ring has one or more flanges configured to frictionally secure the first ring into an aperture defined by the bottom surface of the front support.

In another embodiment, no portion of one or more indexing feet extends into an internal space defined by the left support or the right support.

In yet another embodiment, a first indexing foot of the one or more indexing feet comprises a support surface configured to abut a bottom surface of the front support.

In yet another embodiment, the first indexing foot comprises a first peg having a length and one or more spring detents.

In another embodiment, the right support has one or more rings secured into an aperture defined by a bottom surface, wherein a first ring is configured to receive a portion of the first peg of the first indexing foot.

In at least one embodiment, a first spring detent of the one or more spring detents of the first peg engages with a first edge of the ring.

In another embodiment, a peg foot selectively threadingly engaged with a foot adapter embedded into the bottom surface of the right support.

In a further embodiment, the peg foot has a base that is received into a receiver defined by a support surface of the first indexing foot, wherein the peg foot prevents the indexing foot from rotating about a horizontal axis of the first peg.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not, therefore to be considered to be limiting of its scope, the invention will be described and explained with additional specificity and detail through the use of the accompanying drawings in which:

FIG. 1 illustrates a modular furniture system of the present disclosure;

FIG. 2 illustrates an exploded perspective of a modular furniture system of the present disclosure;

FIG. 3 illustrates a perspective view of a rear support of the present disclosure;

FIG. 4 illustrates a front-aspect view of a rear support of the present disclosure;

FIG. 5 illustrates a side-aspect view of a rear support of the present disclosure;

FIG. 6 illustrates a bottom-aspect view of a rear support of the present disclosure;

FIG. 7 illustrates a perspective view of a right support of the present disclosure;

FIG. 8 illustrates a side-aspect view of a right support of the present disclosure;

FIG. 9 illustrates a front-aspect view of a right support of the present disclosure;

FIG. 10 illustrates a perspective view of a front support of the present disclosure;

FIG. 11 illustrates a rear-aspect view of a front support of the present disclosure;

FIG. 12 illustrates a side-aspect view of a front support of the present disclosure;

FIG. 13 illustrates a bottom-aspect view of a front support of the present disclosure;

FIG. 14 illustrates a perspective view of a suspension system of the present disclosure;

FIG. 15 illustrates a top-aspect view of a suspension system of the present disclosure;

FIG. 16 illustrates a bottom-aspect view of a suspension system of the present disclosure;

FIG. 17 illustrates a pin of the present disclosure;

FIG. 18 illustrates a foot of the present disclosure;

FIG. 19 illustrates a securing mechanism of the present disclosure;

FIGS. 20-38 illustrate a method for assembling a modular furniture system of the present disclosure;

FIG. 39A-1 illustrates a top-down view of an embodiment of a modular furniture system of the present disclosure;

FIG. 39A-2 illustrates an embodiment of an exploded modular furniture system of FIG. 39A-1;

FIG. 39A-3 illustrates an embodiment of a modular furniture system of FIG. 39A-1;

FIG. 39b illustrates an embodiment of a modular furniture system of the present disclosure;

FIG. 40 illustrates a corner system of the present disclosure;

FIG. 41A illustrates a storage system of the present disclosure;

FIG. 41B illustrates a storage system of the present disclosure;

FIG. 41C illustrates a storage system of the present disclosure;

FIG. 42A-42V illustrate embodiments of side supports of the present disclosure;

FIG. 43 illustrates another embodiment of a modular furniture system of the present disclosure;

FIG. 44 illustrates yet another embodiment of a modular furniture system of the present disclosure;

FIG. 45A-45B illustrate a securing system of the present disclosure;

FIG. 46A-46B illustrates a formulaic representation of a modular furniture system of the present disclosure;

FIG. 47A illustrates another embodiment of a support bracket of the present disclosure;

FIG. 47B illustrates another embodiment of a rear mounting block of the present disclosure;

FIG. 48 illustrates an embodiment of the rear mounting block and support brackets of the present disclosure installed onto a modular furniture system;

FIG. 49 illustrates an embodiment of an engagement port of the present disclosure;

FIG. 50 illustrates another embodiment of an engagement port of the present disclosure;

FIG. 51A illustrates a front perspective view of a trapezoidal pin of the present disclosure; the broken-lines in FIGS. 51A-51H are shown for environmental purposes only and form no part of the claimed design; The hole shown in broken-lines can be used during the powder-coating process, e.g., to allow insertion of a hook or tether therethrough to lift the trapezoidal pin off a work surface during the powder-coating process;

FIG. 51B illustrates a rear perspective of the pin shown in FIG. 51A;

FIG. 51C illustrates the back of the top section of the pin shown in FIG. 51A;

FIG. 51D illustrates the front of the top section of the pin shown in FIG. 51A;

FIG. 51E illustrates the back of the bottom section of the pin shown in FIG. 51A;

FIG. 51F illustrates the front of the bottom section of the pin shown in FIG. 51A;

FIG. 51G illustrates a left-side view of the pin shown in FIG. 51A;

FIG. 51H illustrates a right-side view of the pin shown in FIG. 51A;

FIG. 52 illustrates a securing mechanism comprising chamfers of the present disclosure;

FIG. 53 illustrates a side cross-sectional view of a modular furniture system of the present disclosure;

FIG. 54 illustrates a suspension system of the present disclosure;

FIG. 55A illustrates a portion of an embodiment of a securing mechanism of the present disclosure;

FIG. 55B illustrates another portion of an embodiment of a securing mechanism of the present disclosure;

FIG. 55C illustrates a side perspective view of the portion of a securing mechanism shown in FIG. 55A;

FIG. 56 illustrates another embodiment of a suspension system of the present disclosure;

FIG. 57A-C illustrates a method of installing a securing mechanism of the present disclosure;

FIG. 58A illustrates an exploded view of a modular furniture system of the present disclosure;

FIG. 58B illustrates an assembly view of the modular furniture system of FIG. 58A;

FIG. 58C illustrates an assembled view of the modular furniture system of FIG. 58A;

FIG. 59 illustrates an embodiment of a modular furniture system with an indexing foot;

FIG. 60 illustrates another embodiment of a modular furniture system with an indexing foot;

FIG. 61 illustrates the coupling of a ring and peg foot of the present disclosure;

FIG. 62 illustrates the coupling of an indexing foot;

FIG. 63 illustrates an indexing foot of the present disclosure;

FIG. 64 illustrates a peg foot of the present disclosure;

FIG. 65 illustrates a ring for use with a peg and the indexing foot of the present disclosure;

FIG. 66A illustrates a cross-sectional view of an indexing foot coupled with a front support; and

FIG. 66B illustrates a cross-sectional view of a bracket between an indexing foot and a front support.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

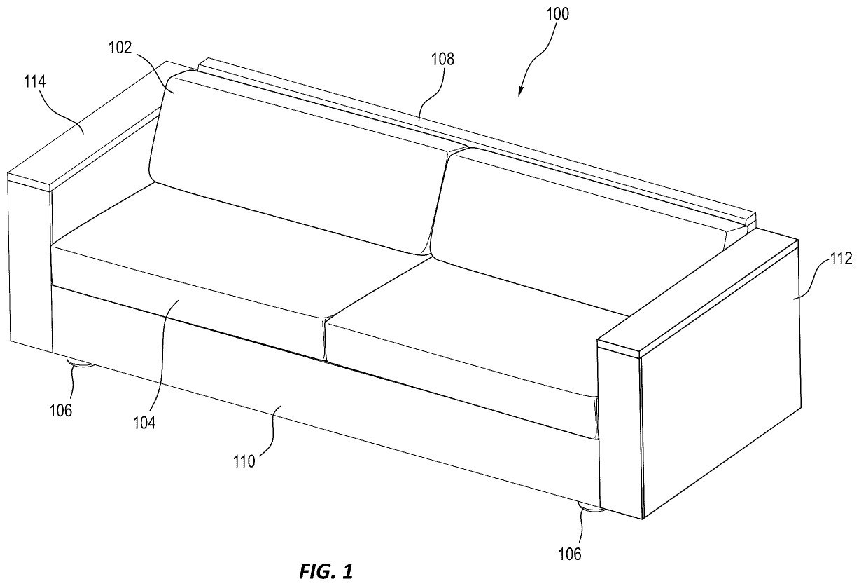

FIG. 1A illustrates an exemplary embodiment of a modular furniture system of the present disclosure. As illustrated, modular furniture system 100 comprises a plurality of cushions. This plurality of cushions includes a plurality of seat cushions 104 and a plurality of back cushions 102. As illustrated, modular furniture system 100 comprises four total cushions. Modular furniture system 100 further comprises a variety of subcomponents, specifically, a plurality of feet 106, a rear support 108, a front support 110, a left support 112, and a right support 114. Each subcomponent is configured to be selectively attached to at least one other subcomponent in manners further described herein.

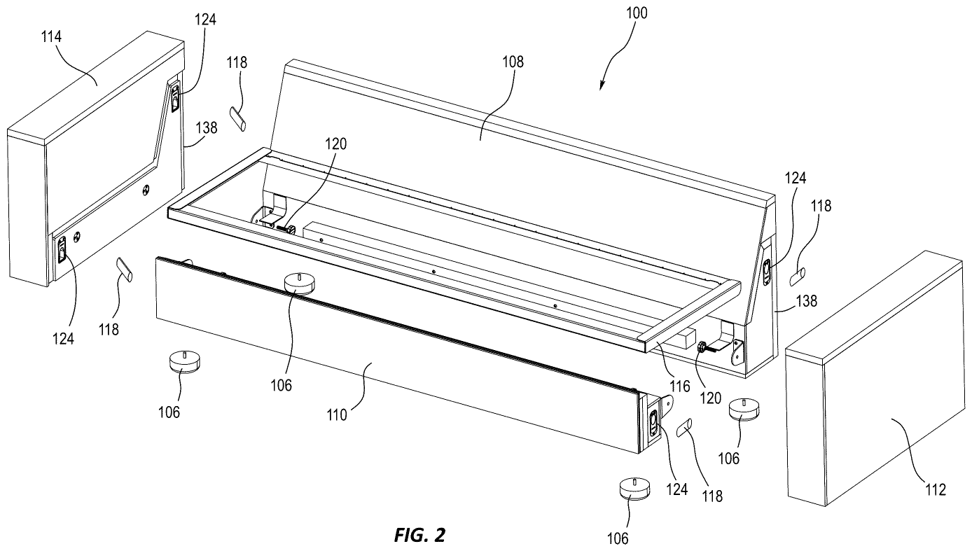

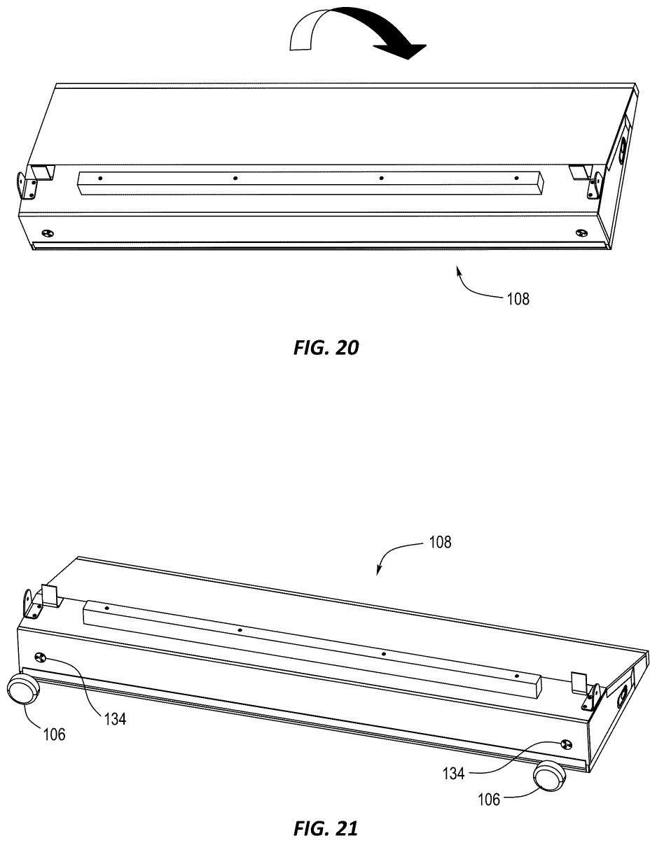

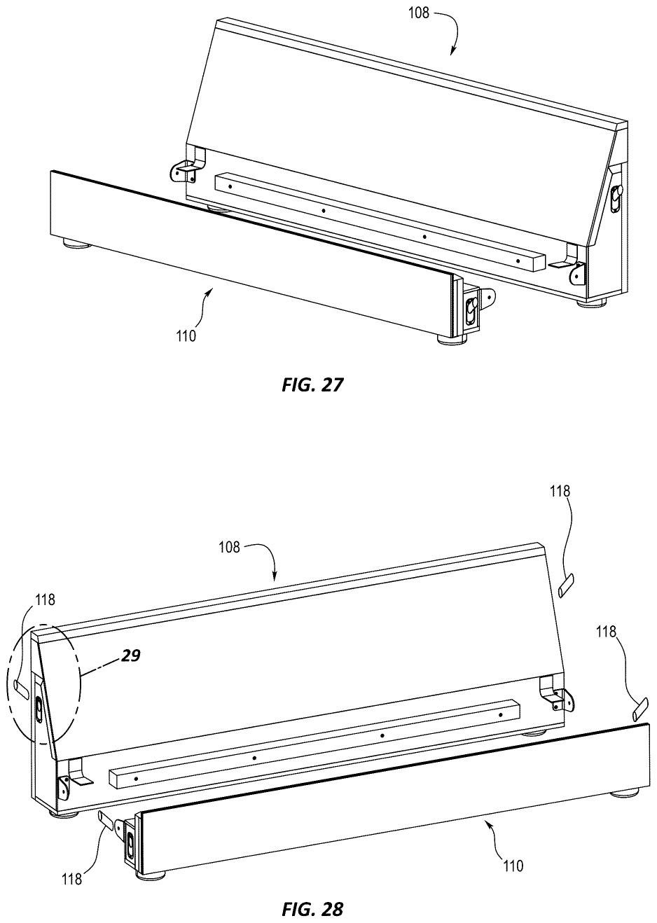

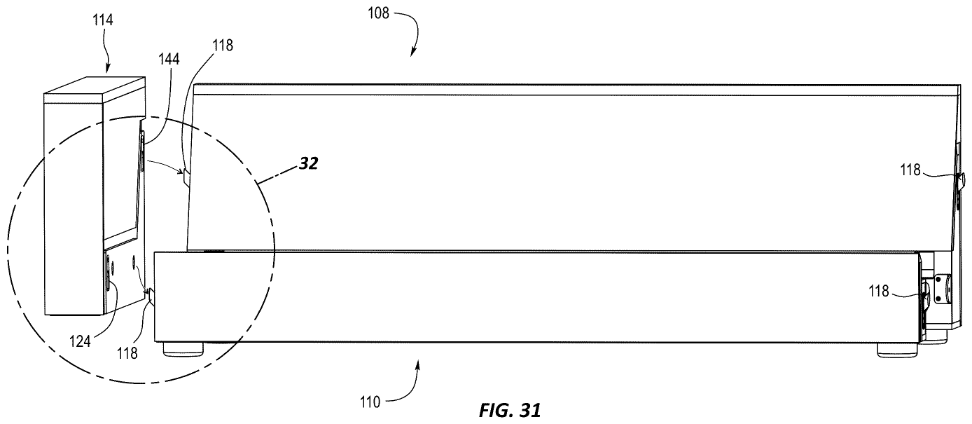

A consumer of modular furniture will appreciate the manner in which modular furniture system 100 is shipped and assembled. A manufacturer ships modular furniture system 100 in at least a partially disassembled state. A partially disassembled state is defined as a state wherein not all sub-components are coupled, connected, or supported. After receiving the shipped modular furniture system 100, the consumer assembles the furniture system 100 as described in FIGS. 20-39. Further, a consumer would appreciate the modularity and customization of that modular furniture system 100 allows, as in a given embodiment, a user can selectively configure a modular furniture system that aligns with a desired functional structure or aesthetic. Additional sub-components can be part of modular furniture system 100, as shown in FIG. 2.

A manufacturer will appreciate that modular furniture system 100 can be disassembled and shipped to a customer in at least a partially disassembled state. This advantageously allows for separate shipping or packaging of any combination of sub-components, allowing a manufacturer to save money on shipping costs and materials. The rear support and front support dimensions are configured so that they are able to be stacked or nested together, along with the suspension system, and stay within the footprint of the rear support. The footprint of the rear support is defined by the height and length of the back face of the rear support or the area of the back face of the rear support. Thus, a box having the base dimensions of the height of the rear support by the length of the rear support would be used. In such a case, the rear support's backside is placed at the bottom of the box, and the rest of the members of the modular furniture system are then stacked on the front face of the rear support. Additional space may be necessary for sufficient packing materials. A manufacturer then ships an entire modular furniture system 100 inside of a single oversized box rather than multiple boxes due to this stacking capability, saving both the end user and manufacturer money.

FIG. 2 illustrates an exploded perspective of modular furniture system 100. While all sub-components of FIG. 1 are shown, additional sub-components are also illustrated. For example, modular furniture system 100 further comprises a suspension system 116, a plurality of pins 118, and a plurality of securing mechanisms 120. As illustrated, at least two feet are selectively coupled to the front support 110, and at least two feet are selectively coupled to the rear support 108. The front support 110 and the rear support 108 are configured to receive a plurality of pins 118. The received plurality of pins 118 then act as structural supports and positioning tools for securing both the left support 112 and right support 114. As illustrated, suspension system 116 is configured to be retained between and by the front support 110, rear support 108, left support 112, and right support 114. At least the front support 110 and the rear support 108 are configured to provide structural support to suspension system 116. In at least one embodiment, the front support 110 is a hide-a-bed mechanism. In another embodiment, however, the hide-a-bed mechanism is secured to or on top of front support 110 and is secured into the right and left support by way of securing mechanisms and adapters.

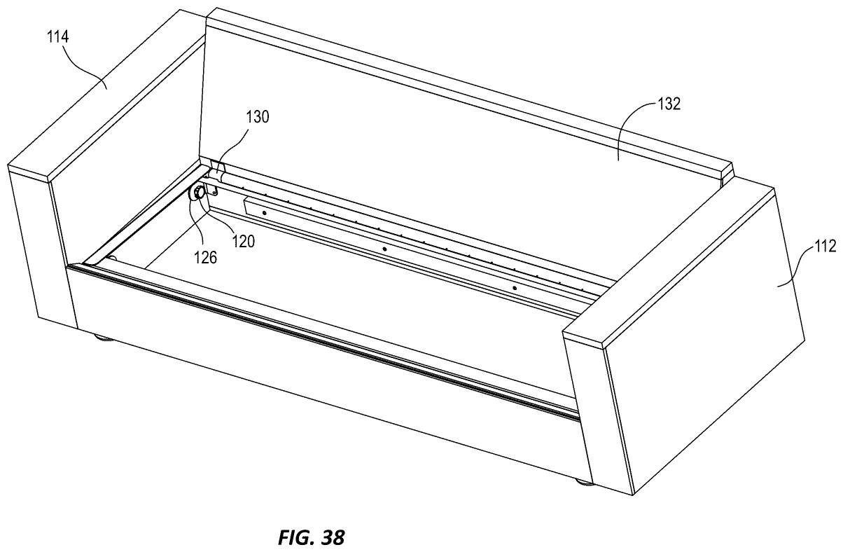

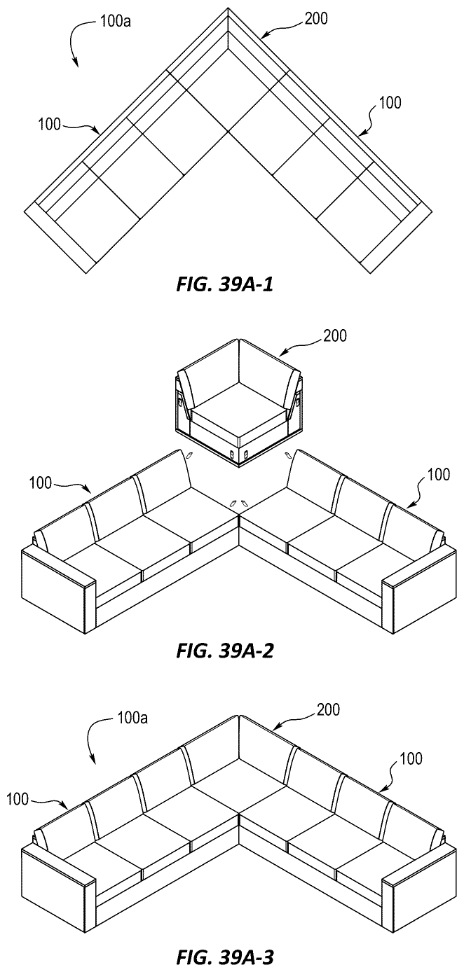

In an alternate embodiment of modular furniture system 100, more or less sub-components are included. For example, modular furniture system 100 is configured to support 3 or more seat cushions 102 and 3 or more back cushions 104. Specifically, a modular furniture system comprises 4 seat cushions 102 and 4 seat back cushions 104, or 5 seat cushions 102 and 5 seat back cushions 104, or 6 seat cushions 102 and 6 seat back cushions 104, or 7 seat cushions 102 and 7 seat back cushions 104, or 8 seat cushions 102 and 8 seat back cushions 104, 4 or 9 seat cushions 102 and 9 seat back cushions 104, or 10 seat cushions 102 and 10 seat back cushions 104, or any combination of seat cushions 102 and back cushions 104. In another example, modular furniture system 100 comprises any multiple sub-components described in this disclosure; for example, as shown in FIG. 39, a modular furniture system comprises at least two front supports 110 and two rear supports 108.

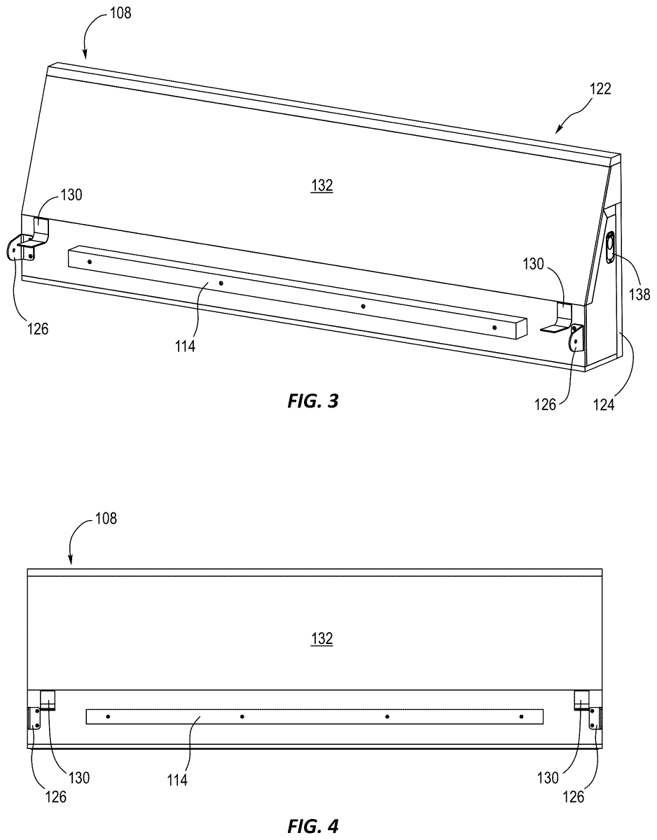

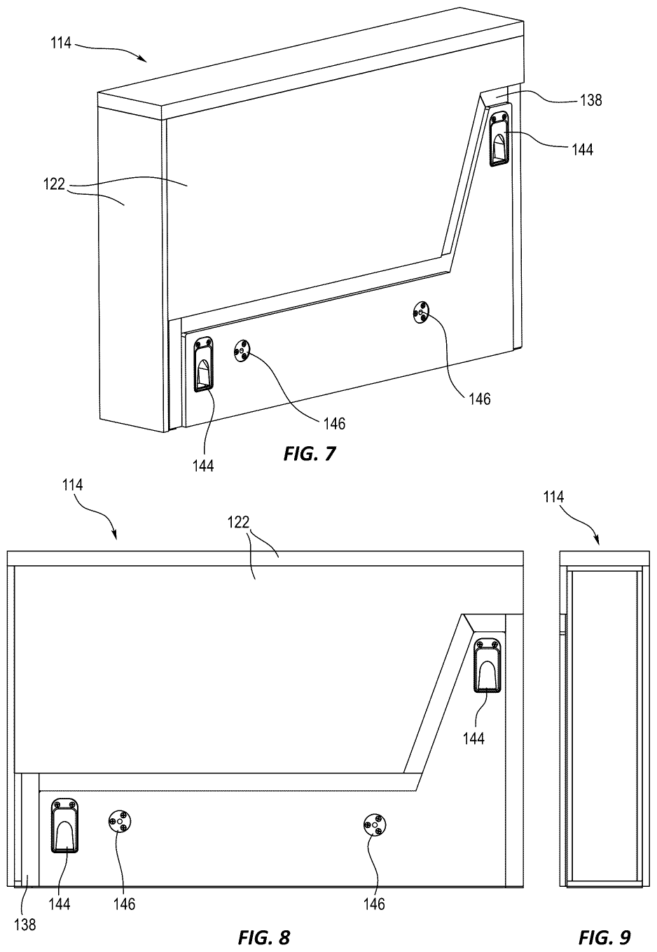

FIG. 3 illustrates a perspective view of a rear support 108. Rear support 108 comprises a cover layer 122, a plurality of engagement ports 124, a plurality of support brackets 126, a rear mounting block 128, a plurality of brackets 130, and a rest 132. Rear support 108 is configured to selectively couple with both a left support 112 and a right support 114. Rear support 108 selectively couples with the left support 112 with a pin 118 and selectively couples with right support 114 with a pin 118 by way of a plurality of engagement ports 124. The engagement ports 124 are configured to selectively receive and retain pins 118 and support at least a portion of either a left support 112 or right support 114 weight. Engagement ports 124 are constructed from a metal, alloy, plastic, or other suitably strong material and are embedded into the opposing ends of rear support 108. Engagement port 124 has a circular, rounded, or oblong opening for receiving pin 118, and an angled internal portion wherein the angle corresponds to the shape and angles of pin 118. When pin 118 is received into engagement port 124, the angle of the engagement port 124 ensures that pin 118 does not slide out while also ensuring that pin 118 protrudes outwardly from rear support 108 such that a corresponding engagement port 144 (shown in FIG. 7) of left or right support 112/114 engage with and be supported by pin 118. Engagement port 144 further comprise a magnet to snap fit a pin 118 inside engagement port 144. Further, engagement port 124 can be secured to rear support 108 through various fasteners, adhesives, or similar securing means.

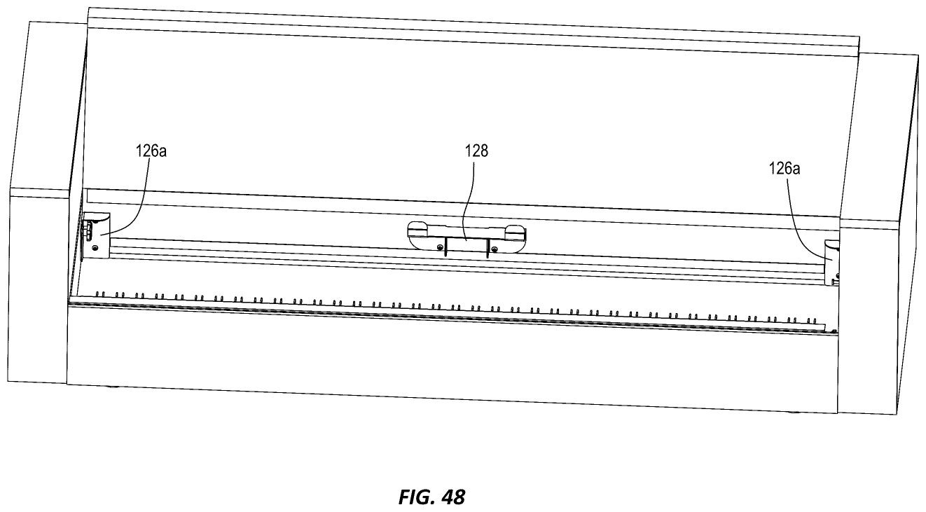

The plurality of brackets 130 are configured to selectively couple with a suspension system 116 or a plurality of suspension systems 116. Brackets 130 can be constructed from metal, alloy, fabric, composite, or other similarly connectable materials. As illustrated, bracket 130 is a fabric member wherein one end is secured to rear support 108 and comprises a hook and loop or similar connective material disposed along it. In such a case, a freed end of bracket 130 can be configured to encompass at least a portion of a suspension system 116 and then be secured back to the hook and loop or similar connective material. A user will appreciate that bracket 130 enables the pivoted movement of suspension system 116 when adequately engaged. This would allow the suspension system 116 to be rotated upwards relative to the surface on which the modular furniture system is placed, allowing the user to access below the suspension system 116, as shown in FIG. 36. While two brackets 130 are illustrated in FIG. 3, a manufacturer can install one bracket 130 or three or more brackets 130 to engage with a plurality of suspension systems 116. In another embodiment, bracket 130 can be a non-fabric member that similarly engages or indexes with a portion of suspension system 116. (shown in FIGS. 47 and 48)

Rear mounting block 128 is constructed from wood, composite, metal, alloy, polymer, or any other sufficiently strong material. Rear mounting block 128 is configured to be secured to rear support 108 by various fasteners, adhesives, or similar securing means. Rear mounting block 128 protrudes from the front face of rear support 128 and is configured to support and position suspension system 116 when it is installed into a modular furniture system of the present disclosure. As illustrated, the rear mounting block 128 extends along a substantial portion of the rear support's 108 lengths and is positioned below the rest 132. Rear mounting block 128 has a substantially flat upper face, as illustrated in FIG. 3. In at least one embodiment, rear mounting block 128 can have an indexing groove or indexing element (see FIGS. 47 and 48) disposed along the length of its upper face. The indexing groove can enable smooth hinging of a suspension system 116, acting as its point of rotation, while also ensuring the suspension system 116 does not fall off or away from the rear mounting block 128 during its rotation.

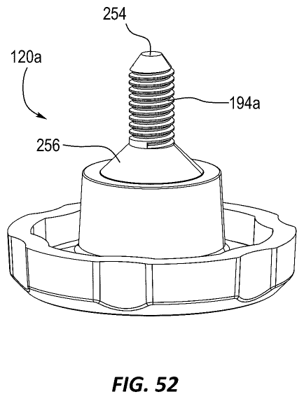

Support brackets 126 are constructed from a wood, metal, alloy, composite, polymer, or any other sufficiently strong material. Support bracket 126 is a bracket member with a substantially 90-degree bend to allow for the cornered connection of the rear support 108 and either a left support 112 or a right support 114. One face of support bracket 126 is secured to rear support 108 through fasteners, adhesives, or similar securing means that form a rigid connection. When secured to rear support 108, the 90-degree bent nature of support bracket 126 presents another face substantially parallel to either left support 112 or right support 114. An aperture is disposed along this face, allowing a securing mechanism 120 to be passed through the aperture and into a corresponding adapter 146 (shown in FIG. 7). Once secured using the securing mechanism 120, support bracket 126, and adapter 146, a left support 112 or a right support 114 will be unable to be removed from its connection with rear support 108 until the securing mechanism 120 is removed. The aperture of support bracket 126 is oversized to allow for engagement with a chamfered securing mechanism 120 (shown in FIG. 52) configured to adjust for or account for any misalignment (excess material such as foam or a cover layer, improper alignment, or any other reason).

Rear support 108 has a cover layer 122 that is disposed on a plurality of its faces and surfaces. As illustrated, cover layer 122 only extends over the surfaces of support 108 that are visible to a user when installed into a modular furniture system of the present disclosure. A manufacturer will appreciate that this configuration reduced the cost of materials as the entire rear support 108 does not need to be covered by a cover layer 122 material. Cover layer 122 can be a fabric, leather, faux leather, cotton, linen, wool, polyester, velvet, microfiber, chenille, acrylic, silk, vinyl, combination thereof, or similarly suitable furniture material. Cover layer 122 can be a monolithic piece/section or can comprise a plurality of pieces/sections that independently secure to rear support 108.

Connector 138 is a hook and loop strip disposed within an indentation. As described, cover layer 122 does not fully encompass any portion of a modular furniture system of the present disclosure. Connectors 138 then allow for the selective coupling of cover layer 122 to the modular furniture system. The indentation or channel in which connector 138 resides enables the cover layer 122 to sit flat to mitigate or refrain from causing an unsightly bump, catch point, or misalignment issues.

Rest 132 is a substantially upright portion of rear support 108 configured to provide a user of a modular furniture system of the present disclosure with backside support when seated. Rest 132 is a backstop for the back cushions 102. Rest 132 can be chamfered or have a taper that allows the back cushions 102 to naturally sit in a declined position and avoid falling forward, even without any additional securing means holding them in place. Beneath the cover layer 122, a manufacturer will include a foam or cushioned material to ensure the modular furniture systems of the present disclosure are devoid of firm edges and corners.

FIG. 4 illustrates a front-aspect view of rear support 108. As shown, the edges of rear support 108 are substantially flat, enabling a solid and firm connection surface for either a left support 112 or a right support 114 to rest against when secured together.

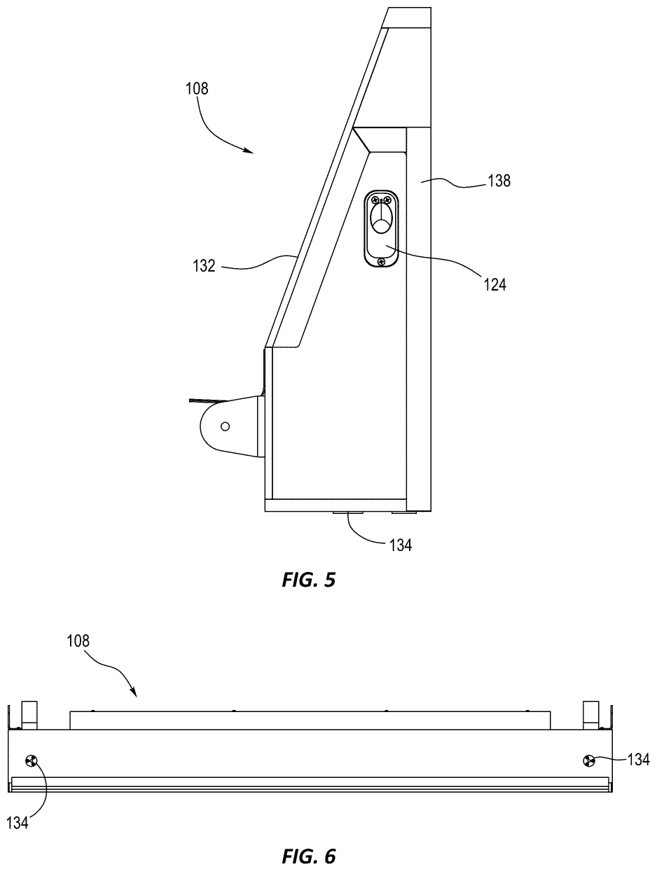

FIG. 5 illustrates a side-aspect view of rear support 108. Specifically, FIG. 5 illustrates the left side of rear support 108. The chamfer of rest 132 is illustrated, showing the declined slope that back cushions 102 would abut when installed. Engagement port 124 can also be seen in greater detail. The circular, round, or oblong entrance of engagement port 124 and the end of the interior portion differ in their relative vertical locations. This difference is derived from the angle at which engagement port 124 is configured. As described above, this angle allows pin 118 to protrude upwards and away from rear support 108, better allowing for left side support 112 to suspend from and be supported by pin 118. The side profile of foot adapter 134 can be seen as well.

FIG. 6 illustrates a bottom-aspect view of rear support 108. As illustrated, a plurality of foot adapters 134 are embedded onto the bottom face of the rear support 108. Specifically, in FIG. 6, two foot adapters 134 are embedded into the bottom face of rear support 108. Foot adapters 134 have a threaded internal portion that is configured to engage with a threaded post of feet of the present disclosure. Due to the substantially flat nature of the rear support 108, rear support 108 maintains a substantially upright position relative to the surface on which it is placed with or without the installation of feet of the present disclosure.

FIG. 7 illustrates a perspective view of a right support of the present disclosure. While a left support of the present disclosure is not illustrated as detailed, all features, characteristics, materials, and elements of right support 114 are present on or about left support 112. Right support 114 comprises a plurality of engagement ports 144, a plurality of adapters 146, a plurality of connectors 138, and a cover layer 122. Cover layer 122 is substantially the same as described when discussing rear support 108. As with the cover layer on rear support 108, right support 114 has a cover layer 122 that only covers a portion of the surfaces of right support 114 and engages within a channel or indentation. Similarly, only the surfaces of right support 114 that are visible to a user when installed on an assembled modular furniture system of the present disclosure are covered by cover layer 122 and a foam or cushions material layer. Right and left supports of the present disclosure further comprise a handle. These handles enable a user to carry or manipulate the right or left support during assembly, disassembly, or otherwise. Handles of the present disclosure are a fabric member secured by sewing, screws, adhesive, staples, or similar means. In at least one embodiment, a handle is a concave rigid portion disposed on the right or left support. In such an embodiment, the handle is a ledge or hold that a user can grasp.

As previously described, adapters 146 are configured to enable a user to selectively secure right support 114 to either front support 110 or rear support 108. The two adapters 146 located on right support 114 are threaded to receive the threads of a securing mechanism 120 and are spaced along the depth of right support 114. Additional adapters can be present to threadingly engage with a plurality of accessories such as cup-holders, working surfaces, pockets, charging systems, or the like.

One or more engagement ports 144 are embedded along the depth or internal face of right support 114. Engagement ports 144 are configured to receive pins 118 that have been installed into the engagement ports 124 located on the rear support 108 and the front support 110. As illustrated, engagement ports 144 have an arched, circular, oblong, or rounded opening and an internal portion that receives an end and at least a portion of a pin 118. Engagement ports 144 are configured to enable right support 114 to suspend from the inserted pins 118. This suspension can be described as a cleat suspension system.

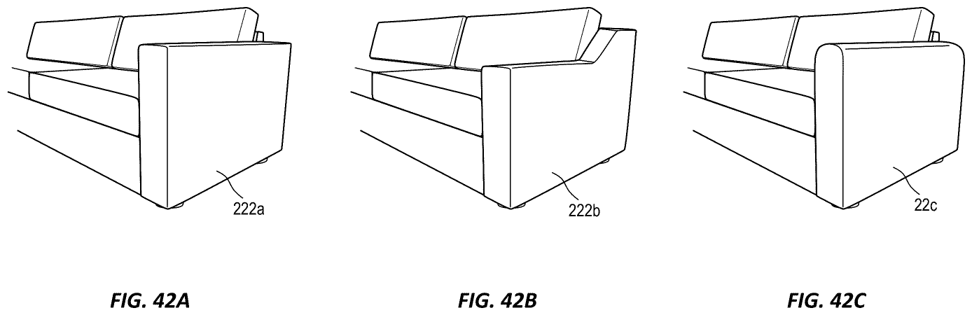

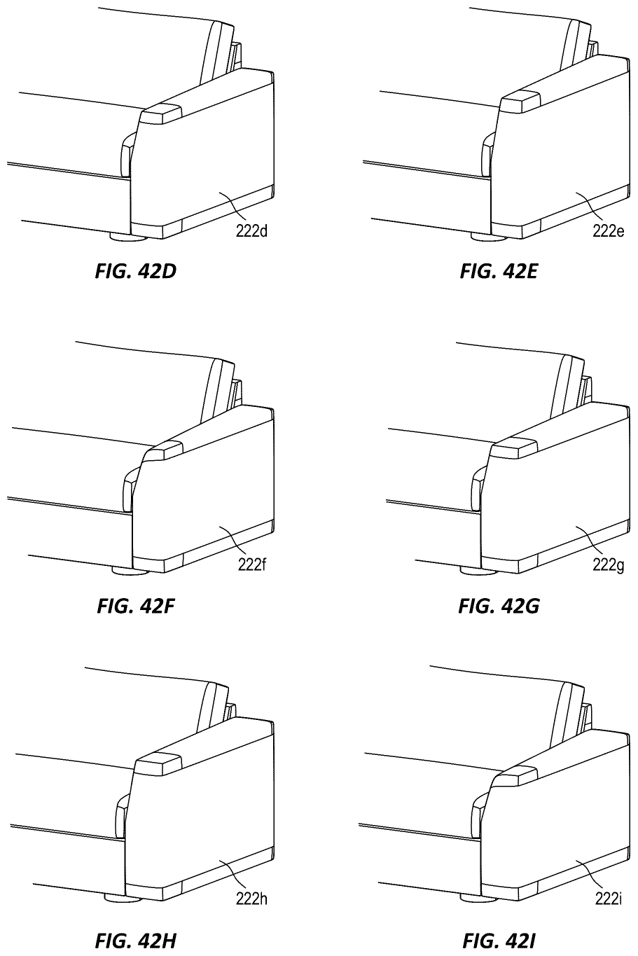

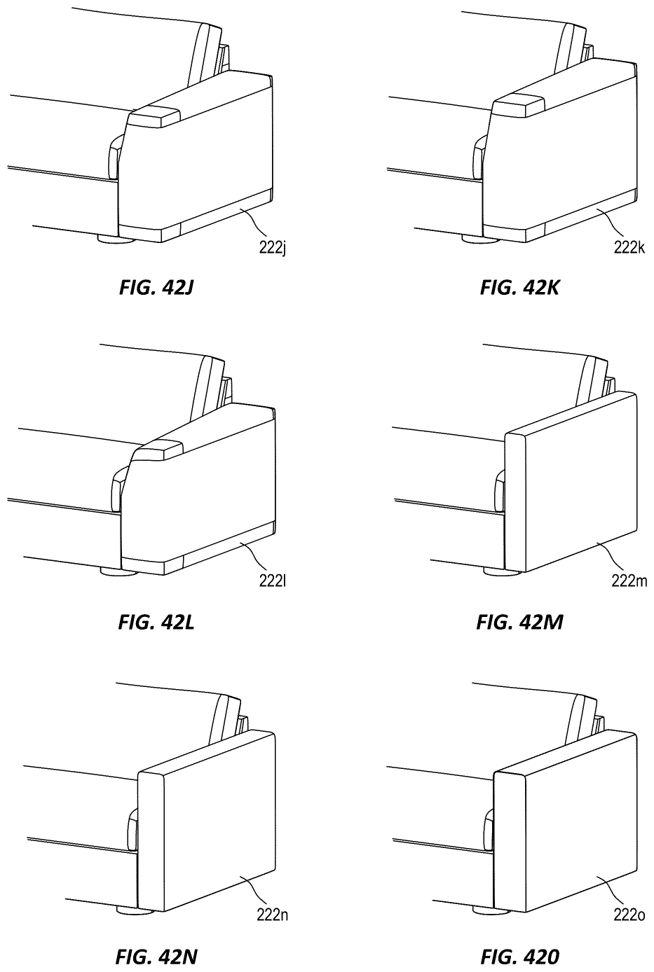

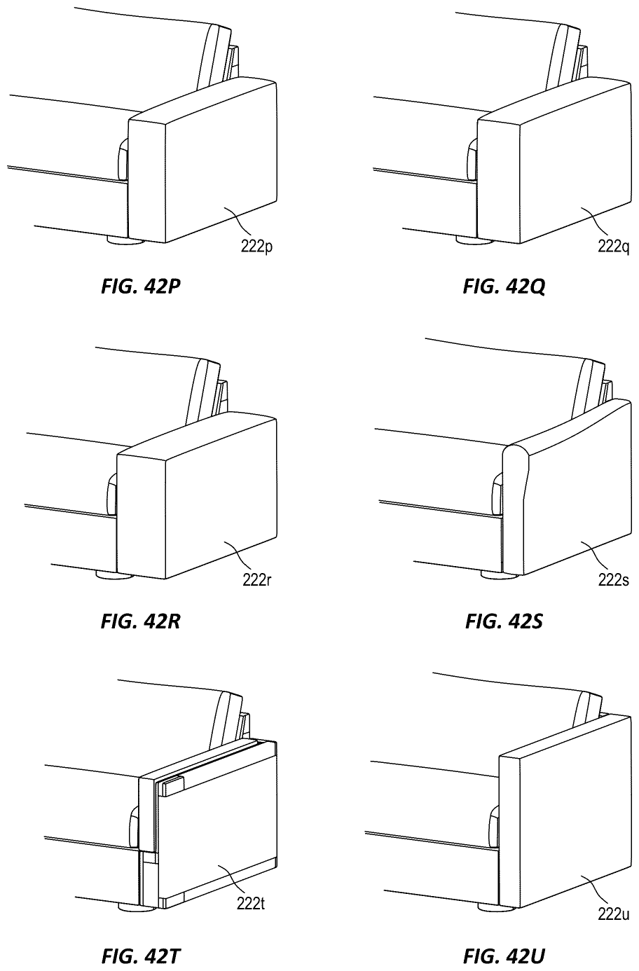

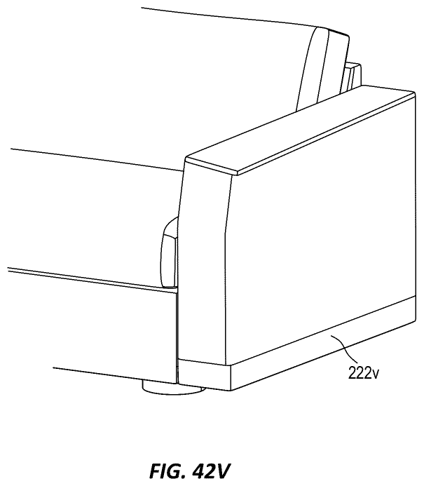

Right support 114, as shown in FIGS. 7, 8, and 9, is substantially squared on all of its edges. In additional embodiments, one or more of the edges of right support 114 can be curved, rounded, sloped, or not square, as seen in FIG. 42. FIG. 8 illustrates a side-aspect view of right support 114. FIG. 9 illustrates a front-aspect view of right support 114.

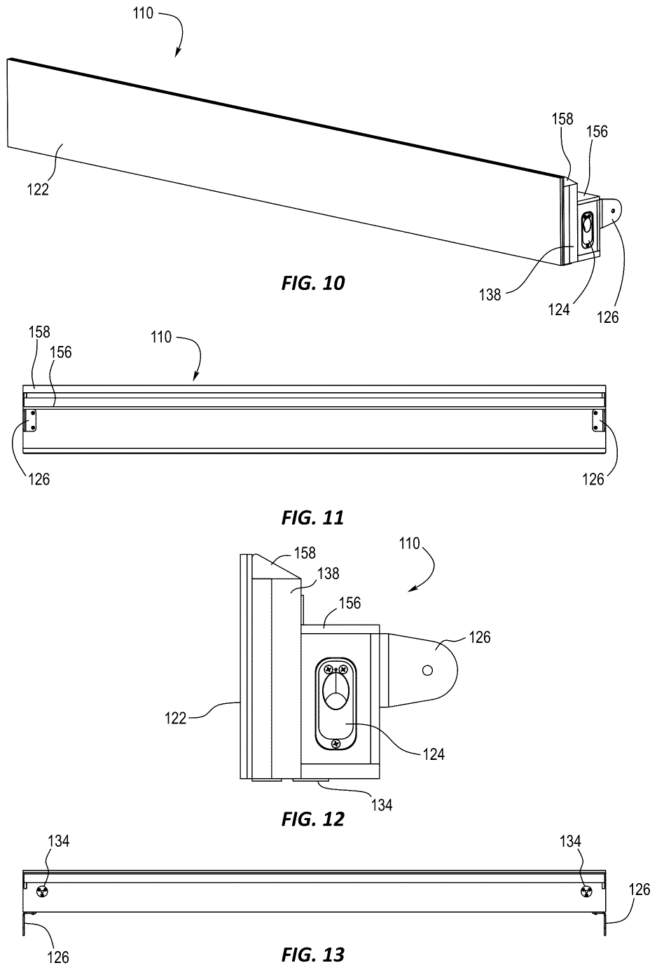

FIG. 10 illustrates a perspective view of front support 110. Front support 110 comprises a plurality of engagement ports 124, a plurality of support brackets 136, a support front support shelf 156, cover layer 122, and a rest 158. The cover layer that is disposed on at least one surface of the front support 110 is substantially similar to the other cover layers 122 described herein, including engaging within an indentation or channel. As such, cover layer 122 is only disposed along some of the surfaces of front support 110, specifically the surfaces visible to a user when front support 110 is installed onto a modular furniture system of the present disclosure. Engagement ports 124 have the same characteristics and configuration as engagement ports 124 located on the rear support 108. They are configured to receive a pin 118 and are embedded and secured into the opposing ends of front support 110 just as they are on rear support 108.

Similarly, the support brackets located on opposing ends of the front support are the same as the support brackets 126 that are described in reference to the rear support 108. Support brackets 126 are configured to secure left support 112 or right support 114 to the front support 110 by passing a securing mechanism 112 through an aperture, or oversized aperture, located on the support bracket 126 and into an adapter 146 located on a left or right support. As previously discussed, an oversized aperture is an aperture configured to engage with a chamfered portion of a threaded securing mechanism.

The front mounting shelf 156 and the rest 158 are configured to aid in the support and indexing of seat cushions 104 and suspension system 116, which are a part of the modular furniture systems of the present disclosure. Specifically, front mounting shelf 156 is configured to provide a flat surface where suspension system 116 rests or is supported when installed in a modular furniture systems of the present disclosure. The upper surface of the front mounting shelf 156 is positioned at substantially the same vertical height as the rear mounting blocks 128 upper surfaces, ensuring that the suspension system 116 lays flat or substantially parallel to the surface on which the front and rear supports are placed. In at least one embodiment, front mounting shelf is mounted slightly higher than rear mounting block 128 to provide a slight backward slope or decline to suspension system 116. Front mounting shelf 156 extends for the entire length of front support 110. Rest 158 is a sloped or angled surface along the upper portion of front support 110 and indexes seat cushions 104 into place. Rest 158 slopes from the front of front support 110 to the back of front support 110, wherein the highest point of rest 158 is at the front of front support 110. This slope or inclination change provides better cradling and supporting of the front and rear portions of seat cushion 104 than if a squared-off indexing element was used. Rest 158 can be constructed from foam, wood, metal, composite, or another suitable material and extends for the entire length of front support 110. Rest 158 is constructed from a foam or cushioned material.

FIG. 11 illustrates a rear-aspect view of front support 110 wherein both support brackets are visible 126 on opposing ends of front support 110.

FIG. 12 illustrates a side-aspect view of front support 110. As with FIG. 5, engagement port 124 and support bracket 126 are more clearly illustrated. The angled internal portion and the circular, rounded, or oblong entrance of engagement port 124 can be seen, and the aperture of support bracket 126 can be seen. Additionally, the side profile of foot adapter 134 is illustrated along the bottom face of front support 110.

FIG. 13 illustrates a bottom-aspect view of front support 110. FIG. 13 shows the placement and spacing of the plurality of foo adapters 134 along the bottom face of front support 110. Just as the foot adapters on the bottom face of the rear support 108, foot adapters 134 have a threaded internal portion configured to engage with the threaded posts of feet 106. As with the rear support 108, front support 110 maintains a substantially upright position relative to the surface on which it is placed with or without the installation of feet of the present disclosure. FIG. 13 also illustrates how support brackets 126 are positioned on the opposing ends of front support 110 to communicate with and remain flush to either left support 112 or right support 114.

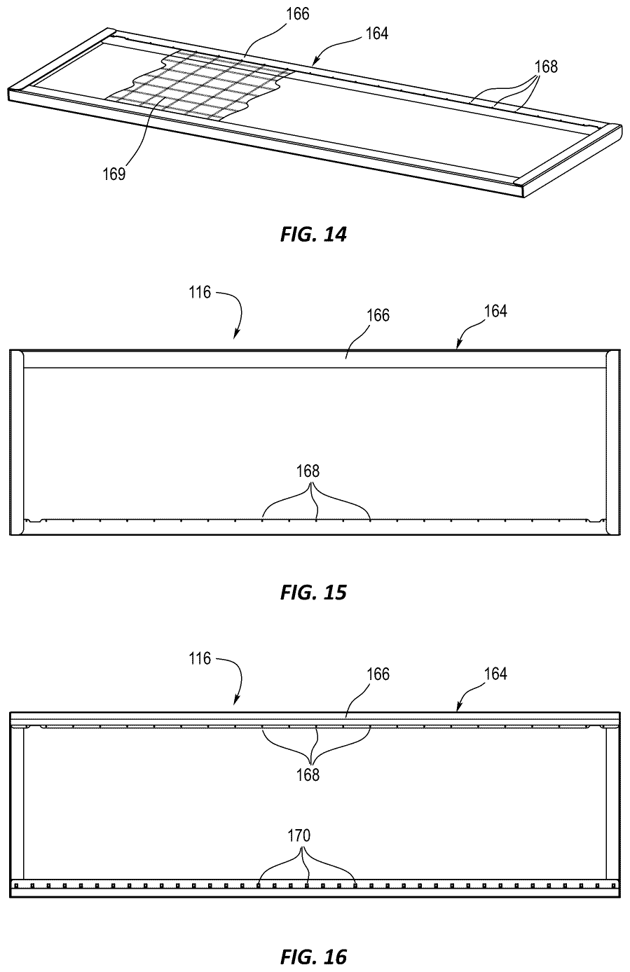

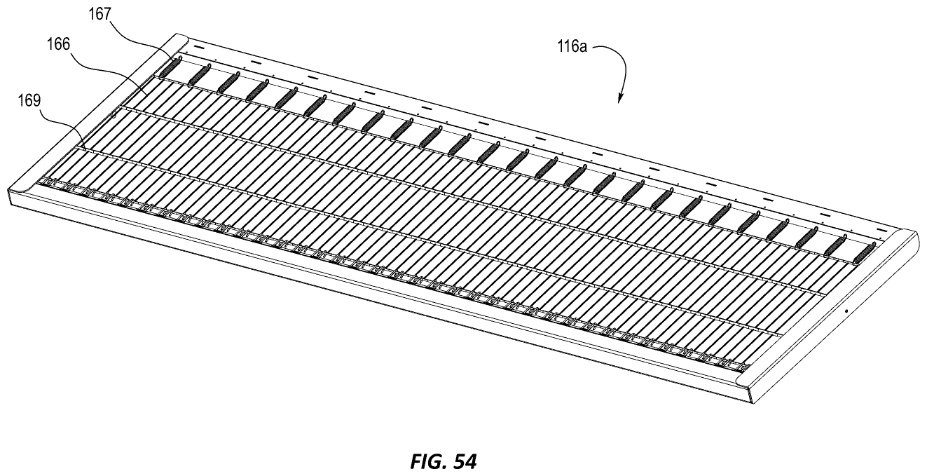

FIGS. 14, 15, and 16 illustrate a perspective view, a top-aspect view, and a bottom aspect view of suspension system 116, respectively. Suspension system 116 comprises at least an outer frame 164 and suspension 166. Outer frame 164 further comprises a plurality of apertures 168 and connectors 170. Apertures 168 and connectors 170 are positioned around the outer frame to allow for the installation and support of a suspension means 166. Suspension means 166 is better illustrated in FIG. 54. As illustrated, suspension system 116 is configured to have a length and depth equal to the inner perimeter created by coupling front support 110, rear support 108, left support 112, and right support 114 together.

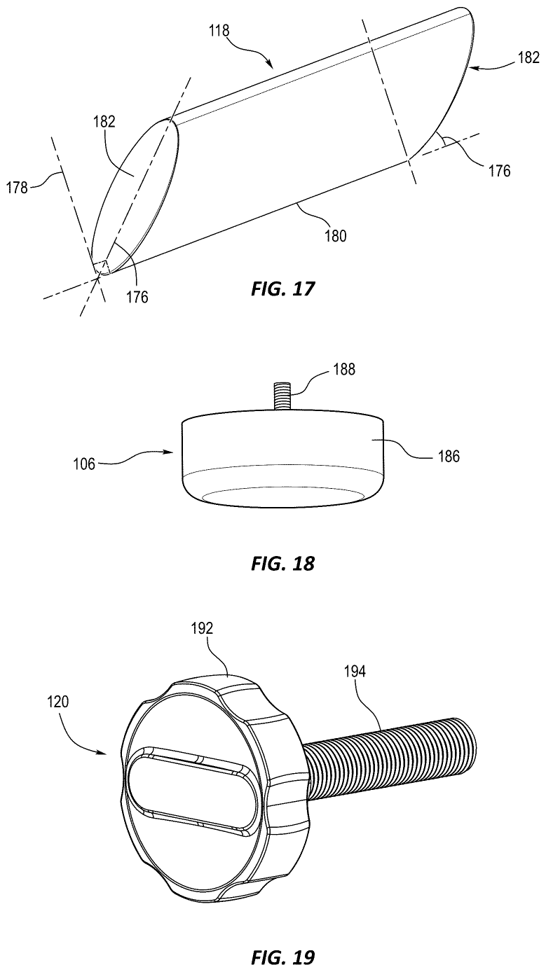

FIG. 17 illustrates a pin 118. As previously described. Pin 118 are angled such that they protrude upward and outward relative to either the front support 110 or rear support 108 that they are inserted into. Angle 176 is derived from a horizontal component 178, and a vertical component 179 imparted onto the end surface 182 of pin 118 relative to the axial plane of pin 118. Angle 176 has a value of greater than 0 degrees but less than 90 degrees, or greater than 15 degrees but less than 75 degrees, or greater than 30 degrees but less than 60 degrees, or has a value of 45 degrees. As shown, both end surfaces 182 have substantially the same angle 176 imparted on them.

A pin of the present disclosure having any degree of angularity in its protrusion from the front or rear support it is received by provides a positive lateral force that is used to tighten the supports of a modular furniture system together. In an embodiment wherein the pins are substantially straight. i.e. the pins are perpendicular in their protrusion from a rear or front support (the vertical component and the horizontal component are both 0 degrees), a chamfered securing mechanism provides a retention force configured to compensate for a net zero lateral force by pulling downwards inwards towards the rear or front support.

FIG. 18 illustrates feet 106. Feet 106 comprise a base 186 and a post 188. Base 186 has a diameter and is substantially circular. The sides of base 186 taper inwards such that the bottom surface, or the surface that contacts the floor, has a smaller diameter than the rest of base 186. A manufacturer can dispose of high-friction or slip-resistant materials along the bottom surface of base 186 or include low-friction or softer materials along the bottom surface to address a specific need. Post 188 is threaded and is configured to couple with the threads of foot adapters 134 of both the front support 110 and rear support 108.

FIG. 19 illustrates securing mechanism 120. As illustrated, securing mechanism 120 is a type of thumbscrew comprising a post 194 that is thread and a base 192 that is configured to allow a user to tighten the securing mechanism 120 without the need for tools.

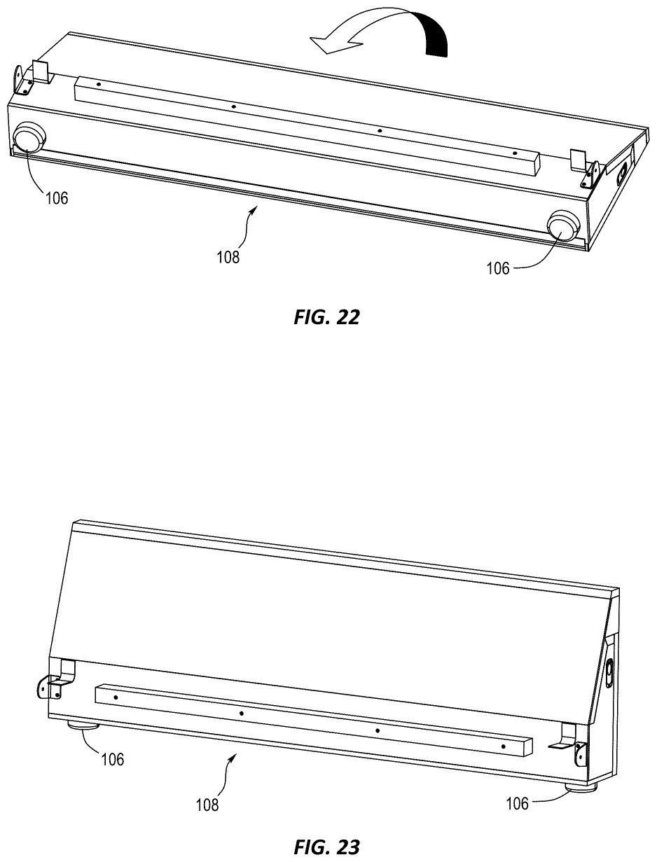

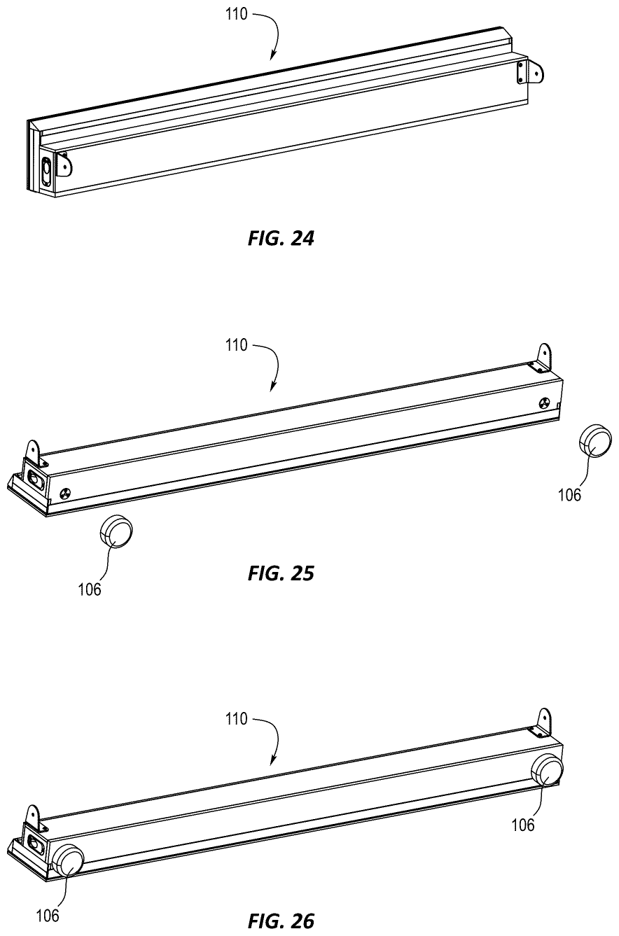

FIGS. 20-38 illustrate a method for assembling a modular furniture system 100 of the present disclosure. It will be appreciated that alternative methods are also possible (e.g., reordering various steps, inclusion of additional steps, or omission of described steps). A user will appreciate the ability to assemble a modular furniture system of the present disclosure alone or with additional help. While not illustrated, a user will also take care to remove packaging and additional items prior to or during the assembly process. First, a user will lay rear support 108 on its back surface, as shown in FIGS. 20 and 21. A user will then install a plurality of feet 106 into each foot adapter 134 on the bottom face of rear support 108. As described above, feet 106 are to be thread into the foot adapters 134. A user will then rotate rear support 108 back into a substantially upright position such that is resting on the installed feet 106 as shown in FIGS. 22 and 23. The feet 106 provide sufficient surface area and support to ensure that rear support 108 can remain upright without assistance. The user will then take and lay the front support 110 onto its frontmost face to expose additional foot adapters 134 as shown in FIGS. 24 and 25. Once exposed the user threads additional feet 106 into the plurality of foot adapters along the bottom face of the front support 110. As with the rear support the user then rotates the front support 110 such that it is being supported by the installed feet 106.

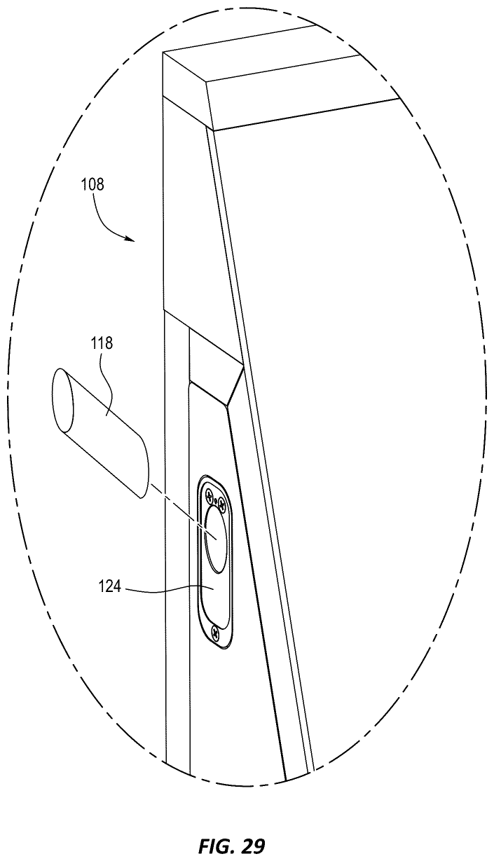

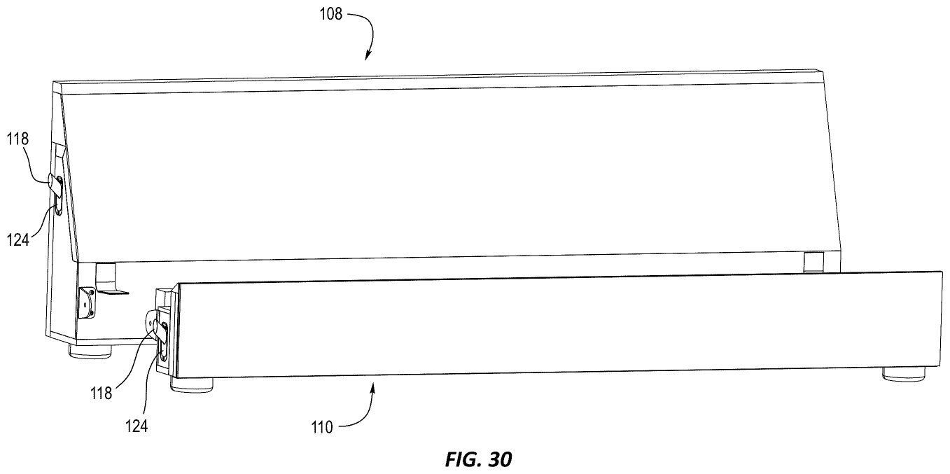

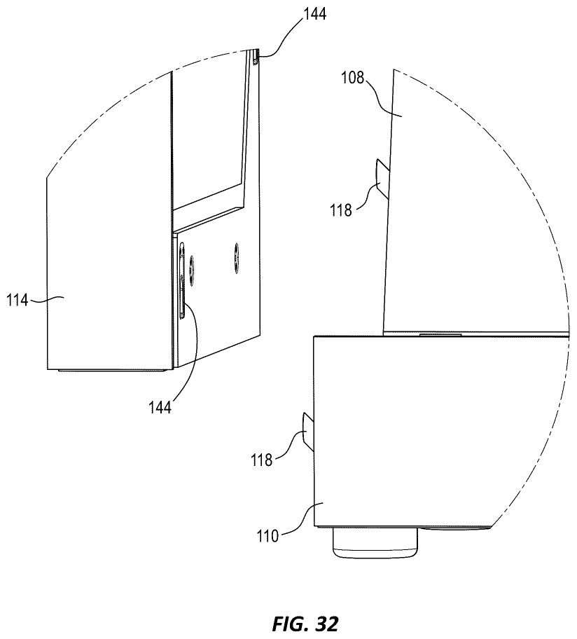

FIGS. 27 and 28 illustrate a user aligning the front support 110 and the rear support 108 so that their lengths are running parallel to one another. The user then installs or inserts a plurality of pins 118 into each of the available engagement ports 124, ensuring that the angles of the pins 118 are indexed correctly into the angular internal portions of each engagement port. A user will hear pin 118 engage with a magnet embedded inside each engagement port. FIG. 29 illustrates a magnified view of this alignment and insertion for pin 118 into the rear support 108. FIG. 30 illustrates the outward and upward protrusion of pins 118 relative to the front support 110 and the rear support 108. The user then aligns the engagement ports 144 on both the right support 114 and the left support 112 to the installed and protruding pins 118. The user then installs either the left support 112 or the right support 114 first, followed by the other. Due to the angled and rounded nature of pins 118 and the locations of the engagement ports 124 and 144, when one side support (left or right) is installed, there is still the ability to adjust and maneuver the second side support onto its respective pins without the help of a second person. FIG. 32 illustrates the alignment process of the engagement ports 144 on right support 114 with pins 118 located on the front support 110 and the rear support 108.

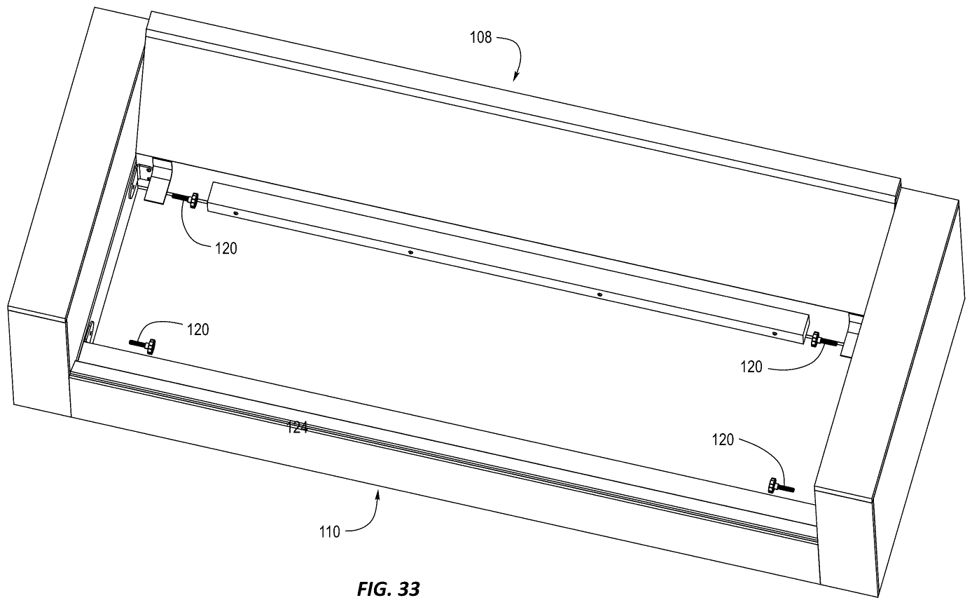

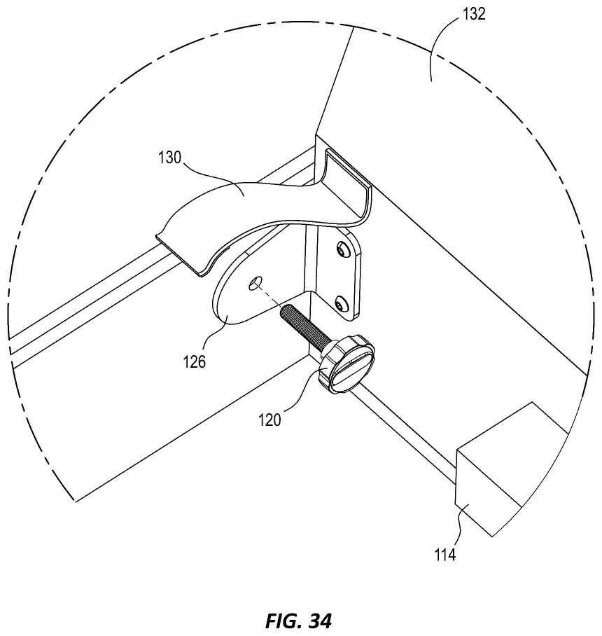

FIG. 33 illustrates the right support 114 and the left support 112 hanging off and secured by the prior illustrated pins 118. To ensure that neither the left support 112 or right support 114 can be lifted or knocked from its resting position on pins 118, a plurality of securing mechanisms 120 are installed, creating a firm connection between the front support 110 and rear support 108 with the right support 114 and left support 112. The securing mechanism is passed through an aperture in a given support bracket 126 and hand-tightened by the user. The oversized nature of the apertures of support brackets 126 provides a margin of error to adapt for any misalignment issues. FIG. 34 illustrates this process in a magnified manner. Once all support brackets 126 have an installed securing mechanism 120, the user installs suspension system 116, as shown in FIGS. 35-38.

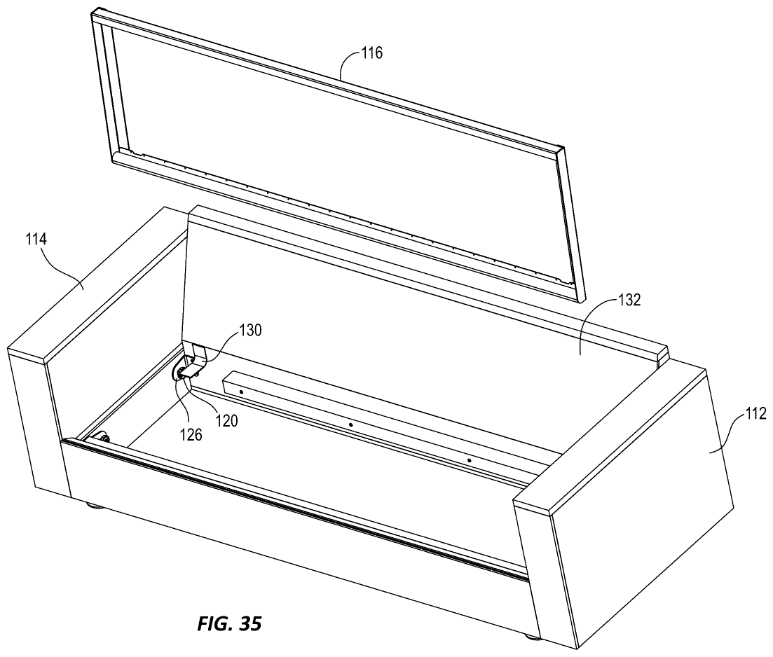

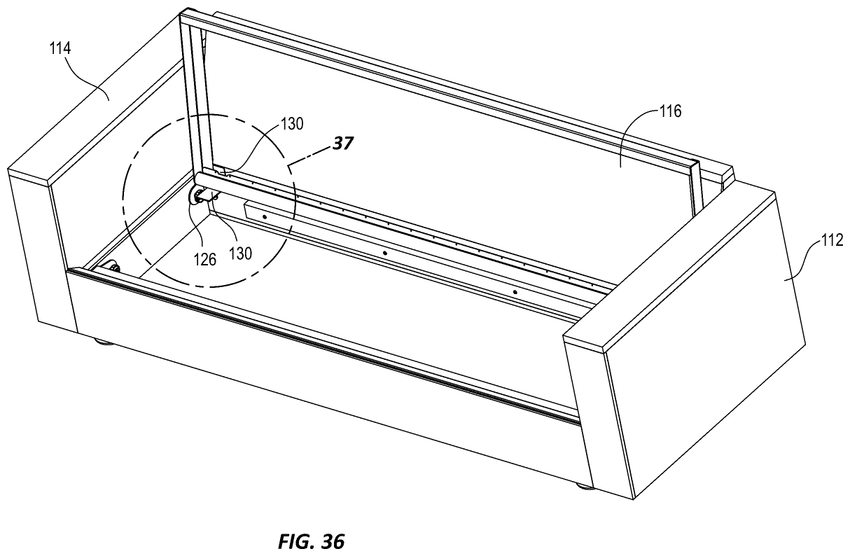

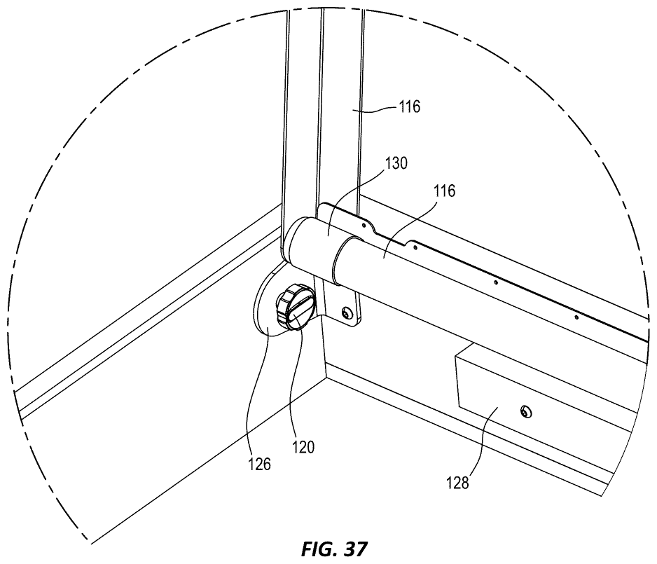

The user first positions a portion of the suspension system 115 onto the rear mounting block 128. With suspension system 116 resting on the rear mounting block 128, the user can secure brackets 130 to the suspension system 116. FIG. 37 illustrates a magnified view of this connection. One secured, the user pivots the suspension system down such that it rest on the front mounting shelf 156 of front support 110. Though not illustrated user can then position the seat cushions 104 and back cushions 102.

FIG. 39A-1, 39A-1, and 39A-3 illustrate an embodiment of a modular furniture system of the present disclosure, modular furniture system 100a. Modular furniture system 100 is constructed from portions of two modular furniture systems 100 wherein the right support of one modular furniture system 100 and the left support of the second modular furniture system 100 are replaced by a corner system 200 that couples with both modular furniture systems 100.

FIG. 39B illustrates another embodiment of modular furniture system 100a. As illustrated, corner system 200 instead comprises two rear supports, 202, that are configured to selectively couple to each other at a corner point. Each rear support 202 is further configured to selectively couple to either modular furniture systems 100. Corner system 200 further comprises a seat cushion as well as a plurality of back cushions. One having ordinary skill in the art will appreciate that corner system 200, as illustrated in FIG. 39B can further comprise similar if not the same connecting and securing systems herein described for various modular furniture system embodiments.

FIG. 40 illustrates corner system 200. Corner system 200 is configured to convert two modular furniture systems 100 into a larger modular furniture system 100a. Corner system 200 comprises a rear support 202, an optional front support 204, a plurality of back cushions 206, a seat cushion 208, a plurality of engagement ports 144, a one or more feet 106. Corner system 200 further comprises a suspension system similar to suspension system 116, varying however in overall dimensions. The front support 204 and rear support are selectively coupled together through the use of a plurality of fasteners. In some embodiments these fasteners are similar to securing mechanisms 120 and a plurality of brackets similar to support brackets 126 are used to ensure a solid connection. The corner system 200 is configured to suspend from or be supported by pins 118 protruding from both modular furniture systems 100 that make up modular furniture system 100a. The feet 106 can be selectively coupled or threaded into the corner system to provide additional support and stability. Mechanisms similar to front mounting shelf 156 and rear mounting block 128 are used by modular furniture system 100a to mount and support a suspension system. Finally, seat cushion 208 and back cushions 206 are installed to enable the user to sit and use corner system 200 as they would with any other section of modular furniture system 100a. In another embodiment, wherein engagement ports are reversable, corner system 200 does not suspend fully or in part from modular furniture system 100a.

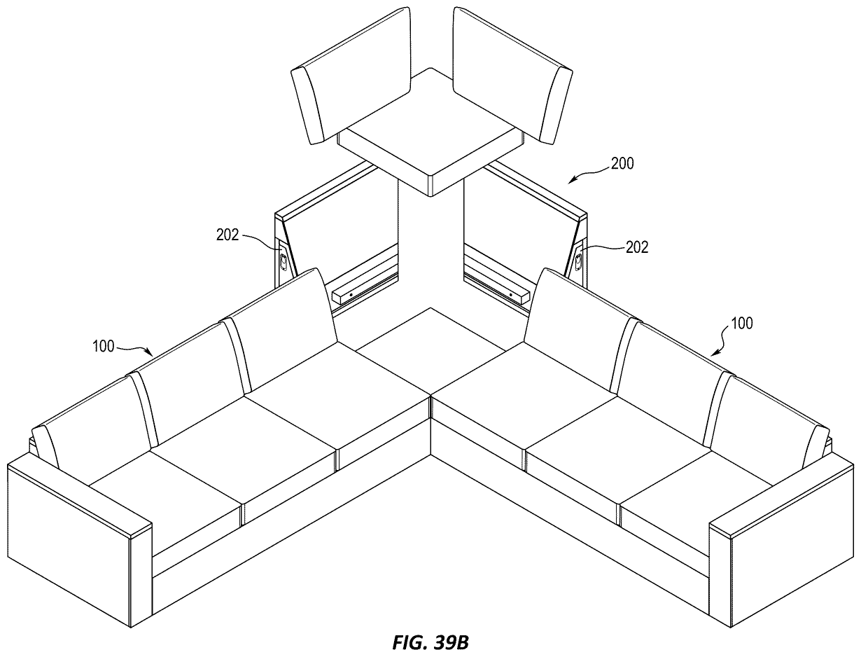

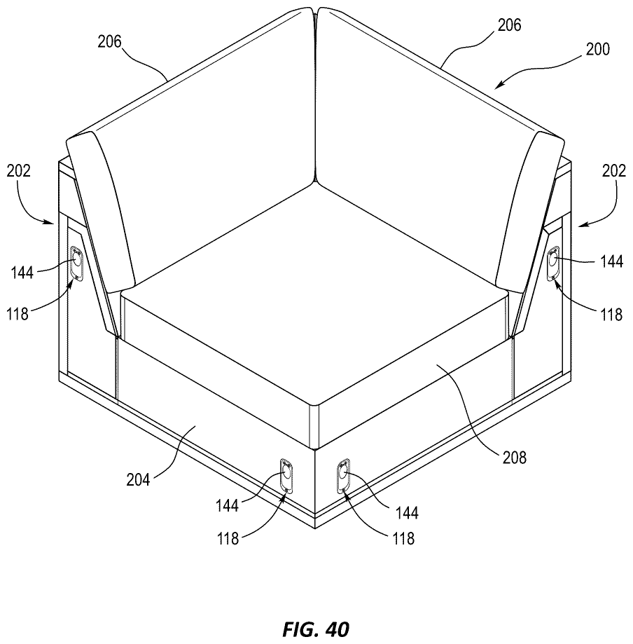

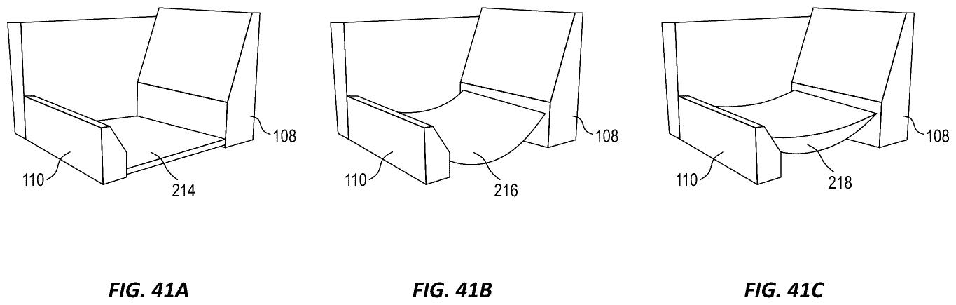

FIGS. 41A, 41B, and 41C illustrate a variety of storage systems of the present disclosure. Storage system 214 is a flat and structured member secured to the front support 110 and rear support 108 of a modular furniture system of the present disclosure. Storage system 214 is secured by fasteners and brackets or supported by support members similar to front mounting shelf 156 and rear mounting black 128 support a suspension system. Storage system 216 is a nonstructural sling element that secures the front support and rear support of a modular furniture system of the present disclosure. Storage system 216 can have rigid members along the edges that connect to the front and rear supports, but the majority of the storage system is constructed from a loose material that can support the weight of items laid across it. Finally, storage system 218 is configured to secure to the front and rear supports of a modular furniture system of the present disclosure and in some embodiment, is either secure to the left and right support of the present disclosure or tailored such that a pouch is formed by the nonstructural material that makes up a majority of storage system 218. The storage systems of the present disclosure are configured to allow for storage of items below the seat cushions and suspension systems of the present disclosure when installed onto a modular furniture system.

In at least one embodiment, storage systems of the present disclosure are selectively configured to couple with only the left supports and right supports of the modular furniture systems of the present disclosure. Depending on the structure of the storage system, only two attachment points may be needed, and those attachment points may be adjacent to each other rather than the parallel attachment points.

FIGS. 42A-42V illustrate a variety of side supports of the present disclosure. Side supports 222a-222v are aesthetic and structural variations or embodiments of left and right supports of the present disclosure. Side support 222c has rounded or softened edges. Side support 222c has a sloped portion along its top region that is swept such that the back of the support is higher than the front of the support. Side support 222c also has rounded or softened edges while also having a wider upper region that is tapered towards the bottom regions of the support. A user will appreciate the variety of side support options available for modular furniture systems of the present disclosure. A user can combine a variety of side supports to form a specific style or aesthetic of a couch that fits their goals. A user can then combine a separate variety of varied aesthetic side supports to form a second specific style or aesthetic of a couch.

As illustrated, the side supports of the present disclosure include at least a taper (varying in angle (30 degrees to 90 degrees relative to a vertical plane) and thickness (1-12 inches)), inch track (from 1-12 inches), Belgian roll, roll, pad, corner, shelter, bend, and track fold styles.

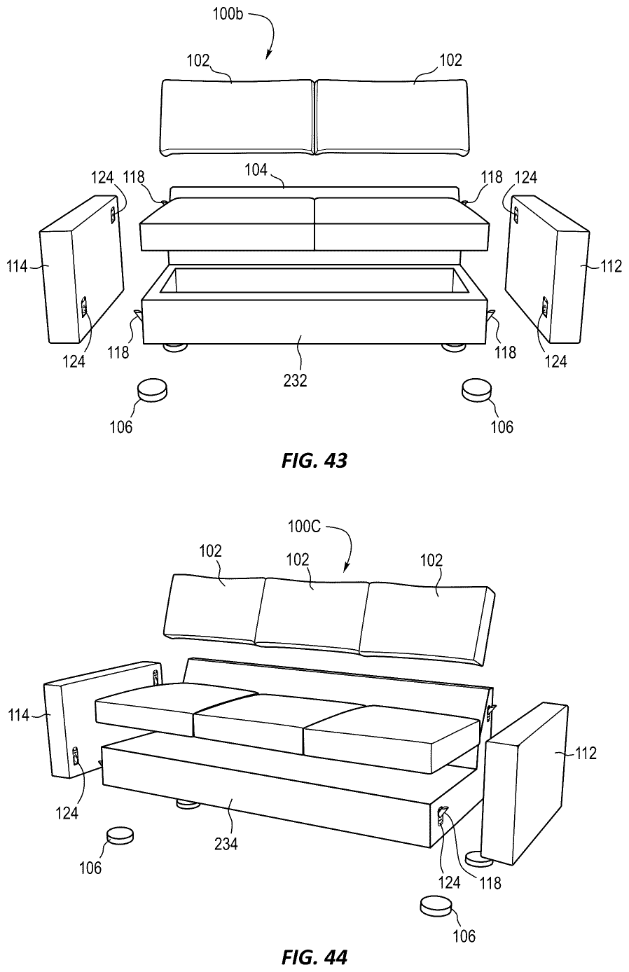

FIG. 43 illustrates another embodiment of a modular furniture system of the present disclosure, modular furniture system 100b. Modular furniture system 100b comprises substantially the same components as modular furniture system 100; however, rather than including a front support and a rear support, modular furniture system 100b comprises a base support 232. Base support 232 comprises a plurality of engagement ports 124 for receiving pins 118. Base support 232 further comprises a rest 160, which enables a user to sit and lean back and additional support for securing a suspension system that would support the seat cushions 104. Similar fasteners to securing mechanisms 120 are used to form a firm connection between the right support 114 and left support 112 with the base support 232.

FIG. 44 illustrates yet another embodiment of a modular furniture system of the present disclosure, modular furniture system 100c. Similar to modular furniture system 100b, there is a base support 234 instead of a front and rear support. Unlike furniture system 100b, however, rather than providing a supported and open area to receive a suspension system, base support 234 has an integrated suspension system such that no additional support system is needed to ensure the support of a user and a plurality of cushions. In another embodiment, seat cushion 104 comprises an integrated suspension system that is configured to engage with and be supported by a base support or front and rear support combination.

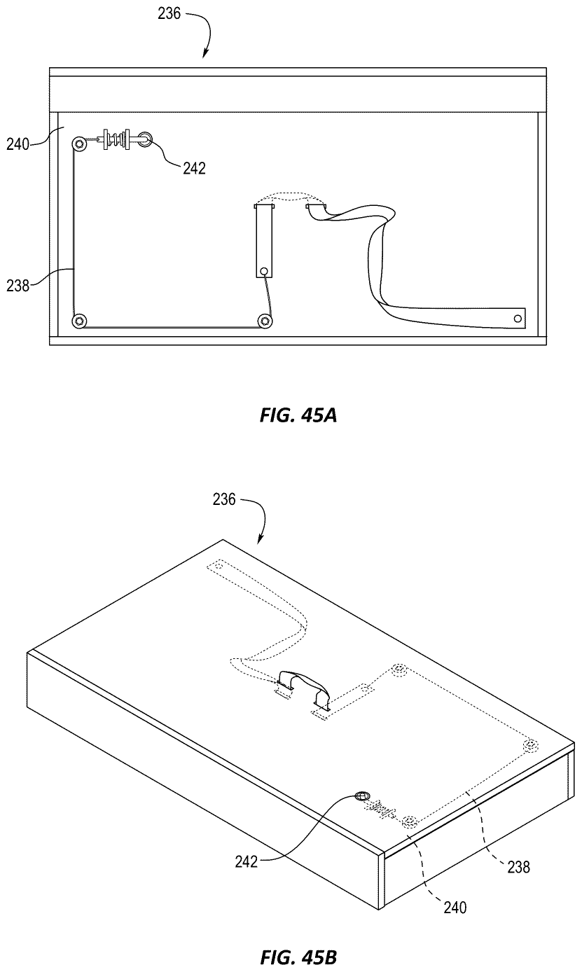

FIGS. 45A-45B illustrate a securing system of the present disclosure. As illustrated a strap is present on the outside of a side support. That strap is in mechanical communication with a cable through the side support wall. The cable is then configured to engage with a plurality of pullies or bearings, which then engages with a spring-loaded mechanism. The spring-loaded mechanism is configured as a connector or latch to secure the side support to a base support, front support, or rear support of the present disclosure.

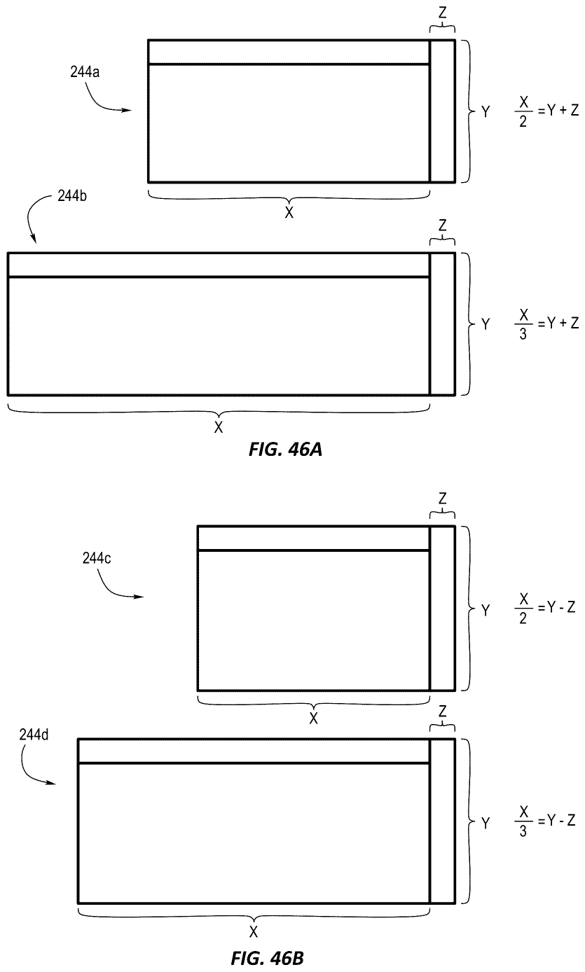

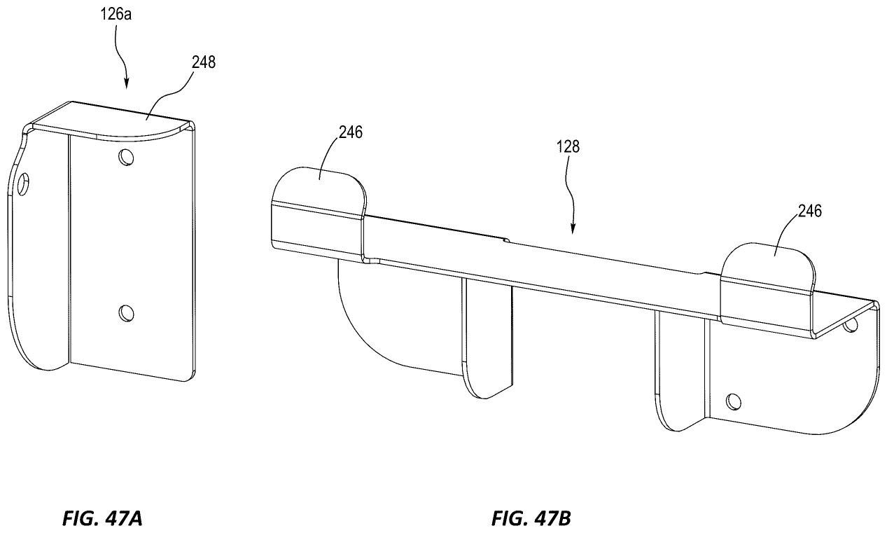

FIG. 46a illustrates a formulaic representation of a modular furniture system of the present disclosure. The modular furniture system described can be represented where the rear support has a length of x, the front support has a length of x, the left support has a length y and a width z, and the right support has a length y and a width z. In embodiment 244a, x/2=y+z. In embodiment 244b, x/3=y+z.

As shown in FIG. 46b, embodiment 244c shows x/2=y−z. In embodiment 244d, x/3=y−z.

In one embodiment of the present invention x can have a value of about 70 inches, about 107 inches, about 58 inches, or about 87 inches. In one embodiment of the present invention, y can have a value of about 29 inches or about 35 inches. In one embodiment of the present invention, z can have a value of about 6 inches. For example, in one embodiment, x has a value of 70 inches, y has a value of 29 inches, and z has a value of 6 inches such that x/2=y+z. In another embodiment, x has a value of 105 inches, y has a value of 29 inches, and z has a value of 6 inches such that x/3=y+z. In another embodiment, x has a value of 58 inches, y has a value of 35 inches, and z has a value of 6 inches such that x/2=y−z. In yet another embodiment, x has a value of 87 inches, y has a value of 35 inches, and z has a value of 6 inches such that x/3=y−z.

The configurations of FIG. 46a-b are highly advantageous and useful, and the dimensions referenced with regard to FIG. 46a-b fit conveniently within a user's home, office, or other spaces and within shipping and handling boxes and containers. It is further advantageous that the front support, rear support, left support, and right supports have planar orientations that allow for flat stacking in shipping.

FIGS. 47A, 47B, and 48 illustrate another embodiment of a rear mounting block, or rear mounting block 128a. As shown in FIG. 47B, rear mounting block 128a is configured to support a suspension system of the present disclosure. As previously discussed, an indexing element, or elements, 246 on rear mounting block 128a allows a suspension system to be retained during rotation or static use of a suspension system to prevent the suspension system from slipping or falling off rear mounting block 128a. Rear mounting block 128a is secured to the rear support and is positioned at the center for the rear support length. As illustrated rear mounting block 128a is shorter than rear mounting block 128 and only extends for less than half of the length of the rear support. FIG. 47A further illustrates another embodiment of a support bracket, similar to support bracket 126. Support bracket 126a provides the same structure benefits as support bracket 126 while further comprising a shelf 248. Shelf 248 is configured to support a corner of a suspension system of the present disclosure. As illustrated in FIG. 48, support brackets 126a and rear mounting block 128a secure to a modular furniture system of the present disclosure in a similar manner as support brackets 126 and rear mounting block 128.

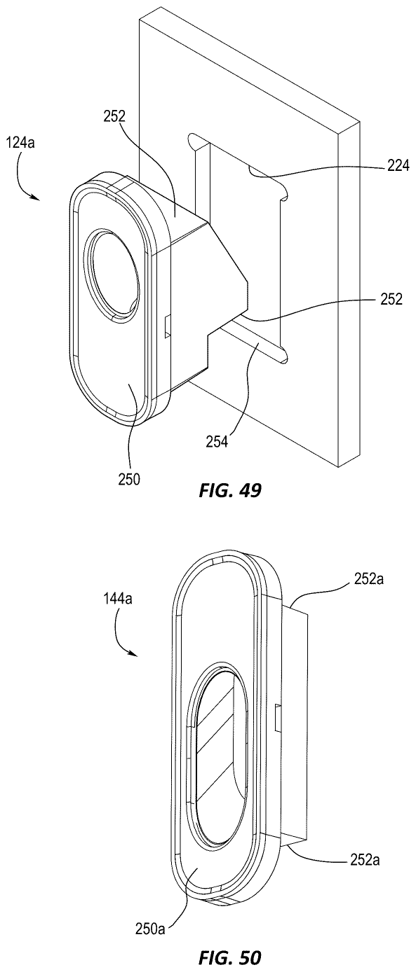

FIG. 49 illustrates an embodiment of engagement port 124a. Engagement port 124a has a similar functionality and structure to engagement port 124. Engagement port 124a further comprises support surfaces 252 and faceplate 250. Support surfaces 252 are configured to interface with corresponding reinforced surfaces 254 of front support or rear support. The reinforced surfaces 254 are additional structural members embedded into a front or rear support of the present disclosure. Support surfaces 252 assists in carrying a load of right or left support rather than only being supported by the screws that secure engagement port 124a to a front or rear support. Reinforced surfaces 254 are utilized strategically to minimize the thickness and overall weight of the modular furniture systems of the present disclosure. Faceplate 250 is removably coupled to the front of engagement port 124. Faceplate 250, when attached, covers the screws that secure engagement port 124a to a front or rear support, providing an aesthetically pleasing surface but also assisting in preventing the screws from backing out of their positions. Engagement port 124a comprises the characteristics and elements of engagement port 124. Similarly, engagement port 124a interacts with a pin of the present disclosure in the manner in which engagement port 124 interacts with a pin of the present disclosure. Engagement ports of the present disclosure further comprise magnets for aligning and retaining pins once inserted.

Engagement port 124a is fully rotatable in at least one embodiment. This means that after removing engagement port 124a from a front or rear support, a user can rotate it so that the top edge is now oriented as a bottom edge when re-secured to the front or rear support. A user will appreciate that this rotation will allow for a high degree of customization, such as allowing the front or rear support comprising engagement port 124a to be fully modular and interact with additional front or rear supports, as well as embodiments of a corner system.

FIG. 50 illustrates an embodiment of an engagement port 144a. Engagement port 144a shares elements and characteristics with engagement ports 144 and 124a. As illustrated, engagement port 144a comprises support surfaces 252a, a magnet (not shown), faceplate 250a, and an opening and an internal portion for receiving and coupling to a pin of the present disclosure.

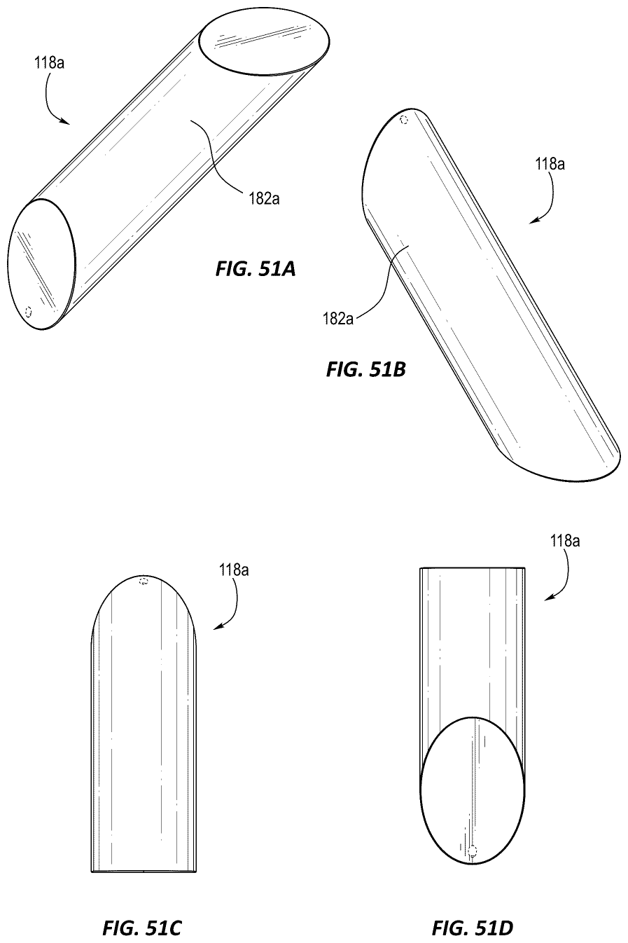

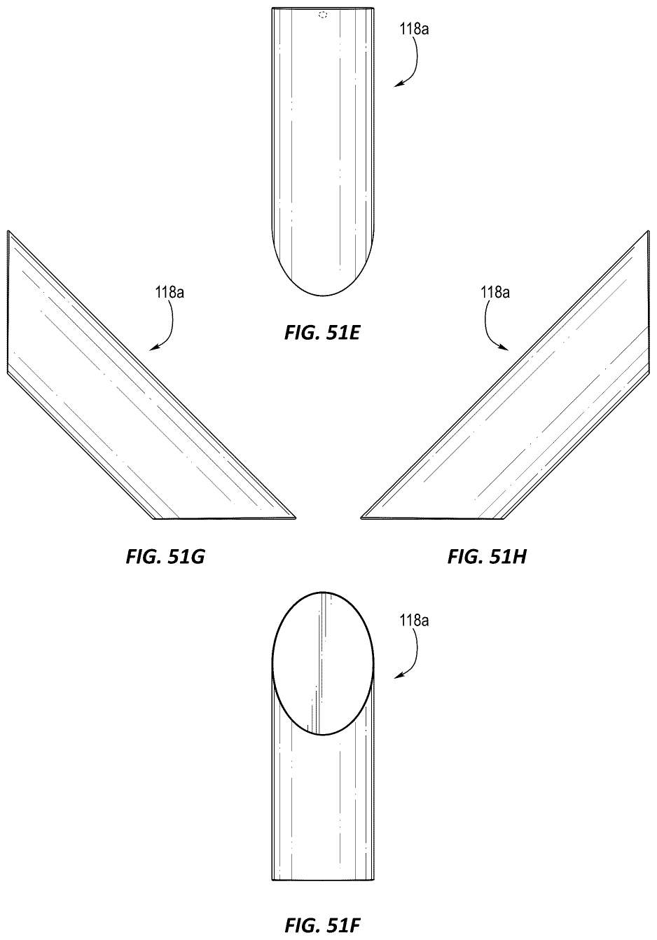

FIGS. 51A-51H illustrate an embodiment of pin 118a. FIGS. 51A-51H further illustrate the ornamentation and all perspectives or views of pin 118a. Pin 118a is angled such that it protrudes upward and outward relative to either the front support 110 or rear support 108 into which they are inserted. As with pin 118, pin 118a has an angle that is derived from a horizontal component, like horizontal component 178, and a vertical component, like horizontal component 180. The end surface 182a of pin 118a, similar to the end surface 182 of pin 118, is angled due to the horizontal and vertical components of pin 118. However, unlike pin 118, pin 118a is trapezoidal in shape. The angle at which pin 118a protrudes from a front or rear support, however, is substantially the same as pin 118. This angle can have a value of greater than 0 degrees but less than 90 degrees, or greater than 15 degrees but less than 75 degrees, or greater than 30 degrees but less than 60 degrees, or has a value of 45 degrees. The trapezoidal shape of pin 118 a adds further stability to the connection between a rear or front support and a left or right support as the weight of a right or left support presses into the rear or front support engagement port, preventing the weight of a left or right support from leveraging or prying pin 118a away from its secured position. The pins of the present disclosure comprise a hanging connector that enables a manufacturer to coat, paint, or otherwise color the pin. Pins of the present disclosure have a diameter of 0.25 inches to 2 inches, such as 0.5 inches, 1 inch, or 1.5 inches. A user will appreciate that the trapezoidal shape of pin 118a inhibits its ability to roll off a surface (e.g., a table or countertop), making placing the pins down before installation easier.

FIG. 52 illustrates another embodiment of a securing mechanism of the present disclosure. Securing mechanism 120a is a thumb screw similar to securing mechanism 120. Securing mechanism 120a, however, further comprises chamfers 254 and 256. Chamfer 254 is disposed of at the outermost portion of the securing mechanisms 126a post 194a. Should securing mechanism 120a be slightly off-axis from entering an adapter during the assembly of a modular furniture system of the present disclosure, chamfer 254 guides post 194a of securing mechanism 126a into the adapter more easily. Chamfer 256 is disposed at the opposing end of post 194a. Chamfer 256 is configured to align a support bracket of the present disclosure to an adapter during the assembly of a modular furniture system. An oversized aperture is used in conjunction with chamfer 256 to assist in the alignment. During the threading of securing mechanism 126a, chamfer 256 engages with an aperture in a support bracket and guides the support bracket into alignment. Securing mechanism 126a can comprise one or both chamfers 254 and 256 in a given embodiment.

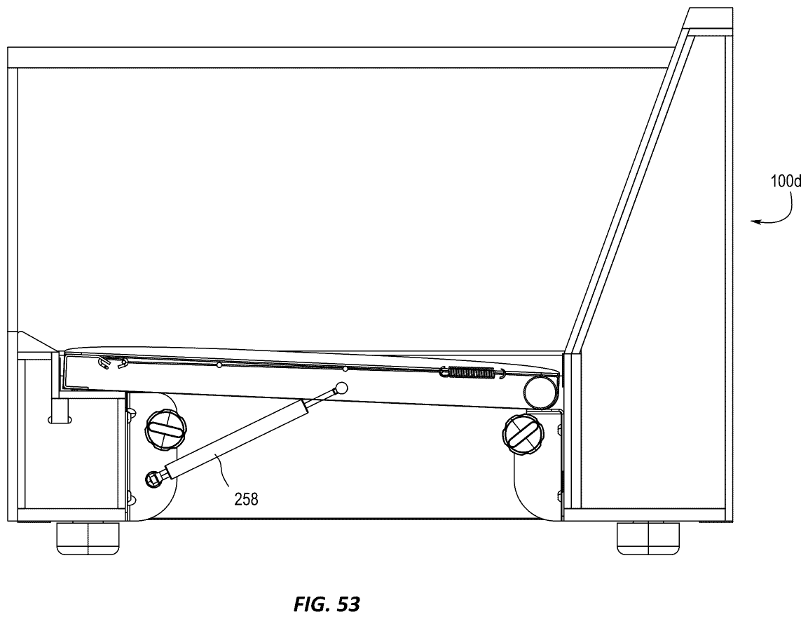

FIG. 53 illustrates modular furniture system 100d. The modular furniture system further comprises an arm 258 configured to allow for a smooth closing and opening of a suspension system. arm 258 is secured to the right support and the suspension system of modular furniture system 258. When a user raises the front of the suspension system, arm 258 is configured to maintain the degree of rotation of the suspension system such that the suspension system remains open and unmoving to allow the user to access a storage system or any item that is below the modular furniture system.

FIG. 54 illustrates a suspension system of the present disclosure. As illustrated, suspension system 116a comprises a plurality of cables 166, a plurality of springs 167, and a plurality of spacers 169. As shown in FIGS. 14-16, a plurality of apertures and connectors are configured to selectively couple to the plurality of cables 166 and springs 167. This configuration provides some structural rigidity to support a person or user who is sitting on modular furniture systems of the present disclosure while also allowing for a suspension or cushioning effect. Spacers 169 are perpendicularly coupled to the plurality of cables 166, ensuring that cables 166 do not spread apart when weight is applied. In another embodiment, a plurality of S-springs can be utilized in place of the plurality of cables and springs.

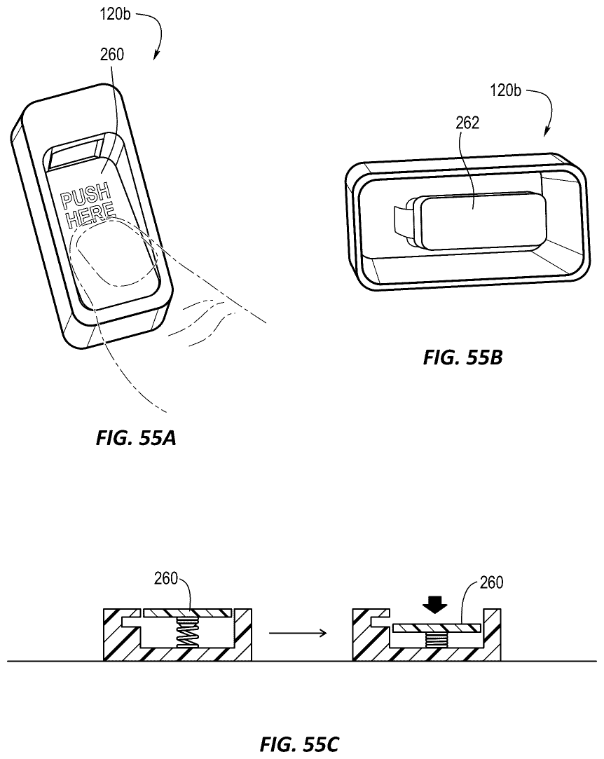

FIG. 55A-C illustrates another embodiment of a securing mechanism (also referred to as a tension coupler) of the present disclosure. Securing mechanism 120b is a spring-loaded latching mechanism that can be embedded into the left, right, front, and rear supports of the present disclosure. Connector 260 and latching mechanism 262 are located in place of the engagement ports of the present disclosure. The female connectors 260 then would interface with latching mechanisms 262 so that the right and left supports would be firmly connected with a front or rear support when inserted. Latching mechanism 262 comprises a spring-loaded latch that interfaces with an opening and shelf within connector 260. When inserted, the latching mechanism is pressed down on the spring-loaded cover of connector 260, revealing the opening and self, wherein the spring-loaded latch of the latching mechanism 262 can engage. The spring-loaded cover of connector 260 then provides a retaining pressure against latching mechanism 262. A release (not shown) is configured to be manipulated to release latching mechanism 262 in order to separate the components of a modular furniture system.

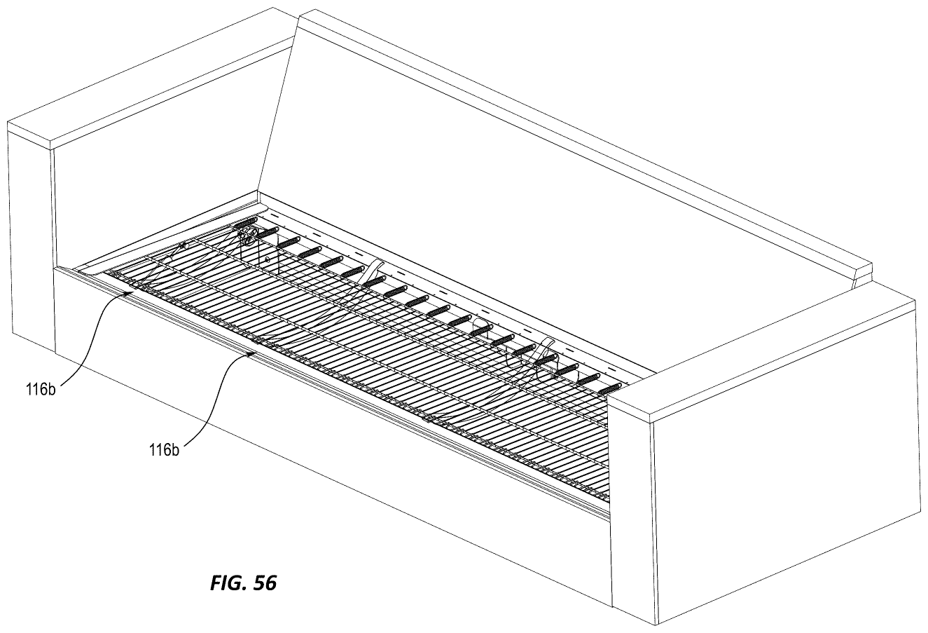

FIG. 56 illustrates another embodiment of a suspension system of the present disclosure. As illustrated, suspension systems 116b are configured to replace or be used in place of any of the previously disclosed suspension systems. Suspension systems 116b do not span the entire length of a modular furniture system; rather, they are independent and are to be configured to support single or multiple cushions. Suspension System 116b has a concave superstructure that is designed to prevent a user of suspension system 116b from feeling a hard edge under their modular furniture systems cushion. This means that sitting between two cushions or between two suspension systems would not result in a user sitting directly on a rigid support structure piece. As with all suspension systems of the present disclosure, a user can rotate or lift the front of the suspension system upwards to reveal either a storage system, the bottom of the modular furniture system, or the floor. As illustrated three suspension systems 116 are deployed within a modular furniture system.

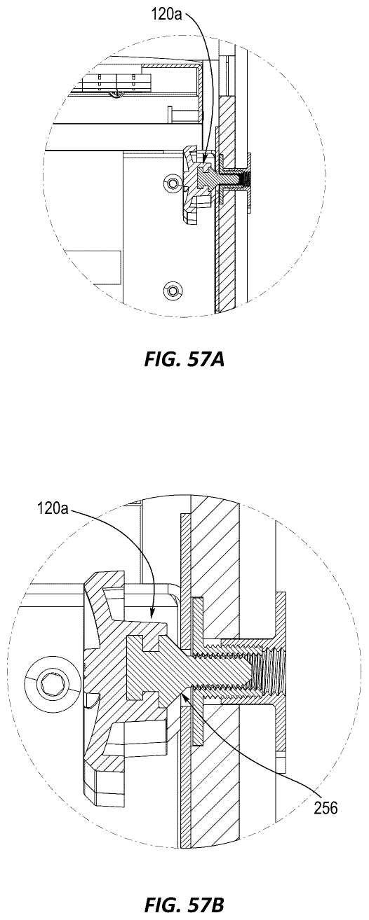

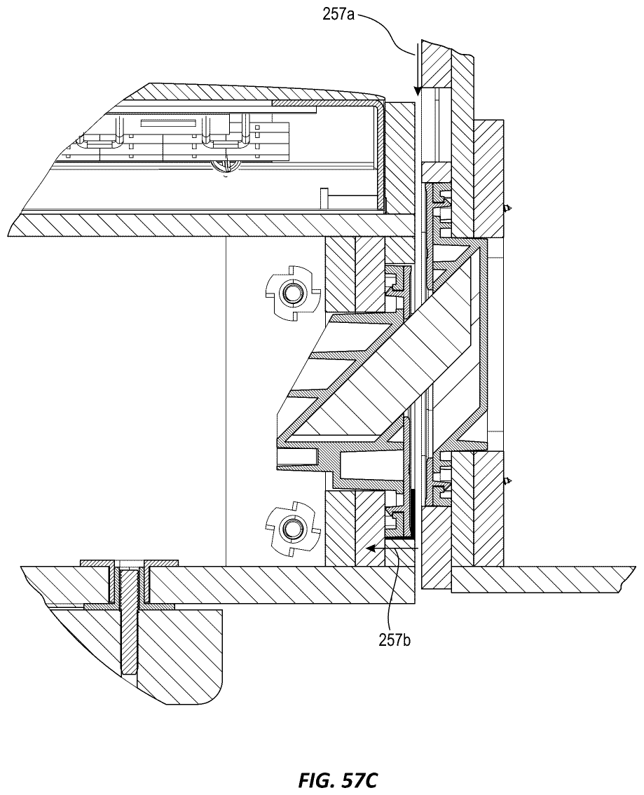

FIGS. 57A-C illustrate the method by which securing mechanism 120a corresponds to an oversized aperture to adapt for and correct any misalignments with a left or right support during installation. As shown, the oversized aperture can first engage with chamfer 256 to account for any variance in fit between the right or left support in relation to the support bracket. In addition to accounting for variances or misalignments, because chamfer 256 first engages with the top section of the oversized aperture, the continued threading of securing mechanism 120a creates tension or pressure on the left or right support by pulling downwards, as shown by vector 257a and 257b. As the left or right support is pulled vertically downward, the angular engagement with the pin of the present disclosure forces the front or rear support closer to the left or right support, creating tension.

A method of installing a right support to modular furniture system can comprise preparing a rear support and a front support as previously discussed, inserting a first pin into an engagement port disposed on a first edge of the rear support, inserting a second pin into an engagement port disposed on a first edge of the front support, and aligning and coupling a right support, wherein a first engagement port disposed on the surface of the right support receives the first pin and a second engagement port disposed on the surface of the right support receives the second pin. Once coupled by way of pins, a user then inserts a first securing mechanism comprising a first chamfer disposed at the base of a threaded post, wherein the first chamfer interfaces with an oversized aperture disposed through a first support bracket, and then threads the first securing mechanism into a first adapter disposed on the surface of the right support. Similarly, a user then inserts a second securing mechanism comprising a second chamfer disposed at the base of the a threaded post, wherein the second chamfer interfaces with an oversized aperture disposed through a second support bracket, followed by threading the second securing mechanism into a second adapter disposed on the surface of the right support. In completing this method, the first chamfer and the second chamfer pull the right support downwards relative to the first pin and second pin and towards the front support and rear support during the threading of the first securing mechanism and second mechanism. This process can be followed for a left support as well.

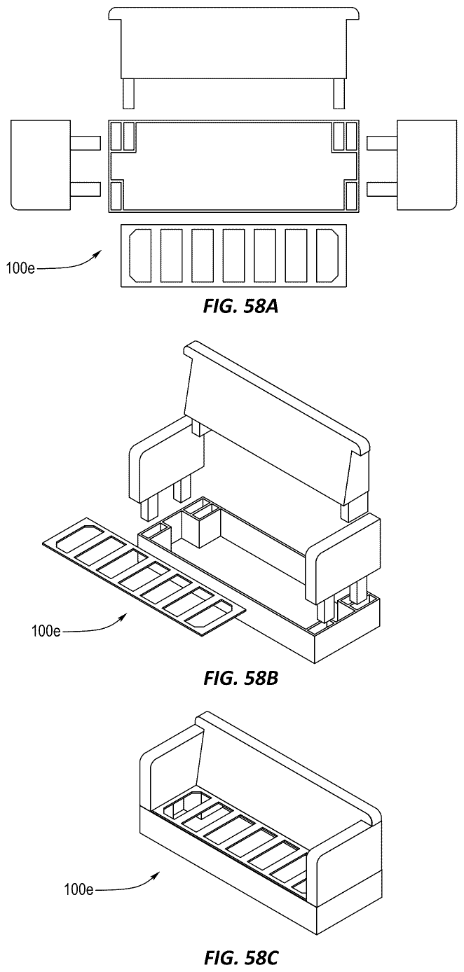

FIGS. 58A-C illustrate modular furniture system 100e. Modular furniture system 100e is comprised of a base, a left support, a right support, a rear or back support, a suspension system, and a plurality of cushions. The rear or back support, left support, and right support are configured to selectively couple with the base by way of pins or alignment elements. The suspension system is configured to either be supported similarly to modular furniture systems previously disclosed or by slidably coupling within grooves disposed on the inner faces of the rear or back support, left support, and right support. Modular furniture system 100e is a vertical install system, wherein it is assembly from the base to the top. For example, the base is first placed, followed by the arms, followed by the rear support, followed by a suspension system and cushion. Modular furniture system 100e further comprises pins that are received by sockets located at the top surface of the left and right supports. The pins protrude downward from the shoulders of the rear support such that they correspond to the sockets.

In another embodiment, a modular furniture system can be coupled using a plurality of slide-fit couplers. These couplers can be configured to slidably engage with corresponding coupler receivers. The couplers and coupler receivers can be disposed of in similar locations to the present disclosure's pins, adapters, and support brackets.

In another embodiment, a modular furniture system comprises a plurality of pin and socket couplers. The pin and socket couplers are configured to selectively couple the supports of the modular furniture system together with a friction fit. In such an embodiment, additional screws, clips, or similar connectors are configured to retain a firm connection between the friction-coupled supports.

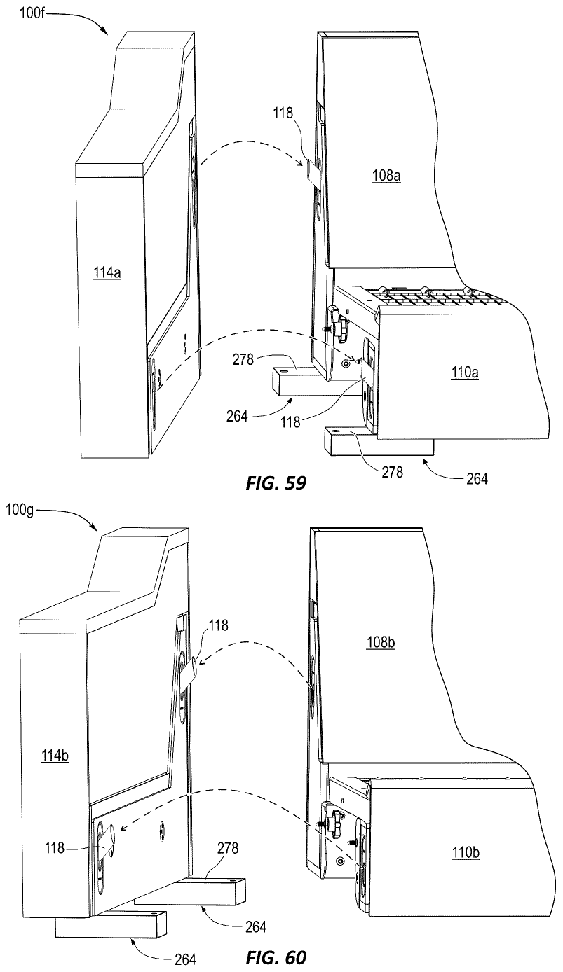

FIG. 59 illustrates an embodiment of modular furniture system 100f with an indexing foot 264. One indexing foot 264 is secured to front support 110a, and another indexing foot 264 is secured to rear support 108a. Each indexing foot extends outward from under either the front support 110a or rear support 108a and towards the right support 114a. When an assembler couples right support 114a to front support 110a or rear support 108a by way of one or more pins 118 of the present disclosure, indexing foot 264 abuts a bottom surface of right support 114a with support surface 278. The support surface 278 stabilizes the modular furniture system by extending supports outwards and under the right support 114a. For example, should a user exert a downward force on right support 114a, that force would be transferred through indexing foot 264, preventing modular furniture system 100f from being tipped over, or wobbling as a result of such force application.

FIG. 60 illustrates the modular furniture system 100g with an indexing foot 264. Modular furniture system 100g is an alternative configuration of modular furniture system 100f. Rather than an indexing foot 264 coupling with front support 110b and rear support 108b, two indexing feet 264 are coupled with right support 114b. Indexing feet 264 outwardly extend from under right support 114b towards front support 110b and rear support 108b. An assembler couples front support 110b and rear support 108b to right support 114b by way of one or more pins 118. As previously discussed, engagement ports of the present disclosure may be rotatable, meaning the orientation of the pin relative to various supports (front, rear, left, or right) can be adjusted by the manufacturer or an assembler. Accordingly, in this embodiment, rather than the front support 110b and rear support 108b effectively hanging right support 114b, instead right support 114b is hanging or supporting front support 110b and rear support 108b. Similarly, support surfaces 278 of the two illustrated indexing feet 264 would abut the bottom surfaces of each of front support 110b and rear support 108b, respectively.

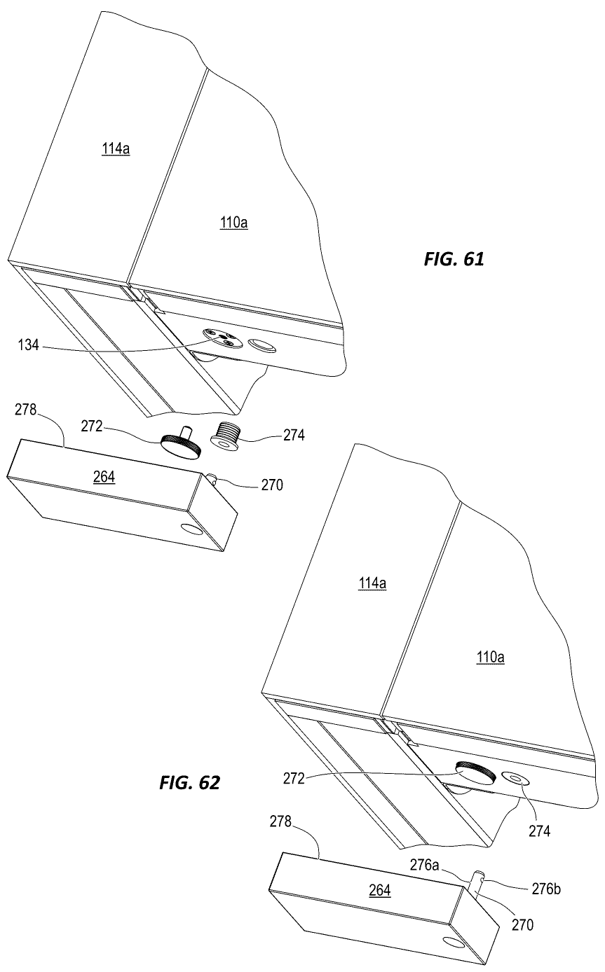

FIGS. 61 and 62 illustrate the coupling of an indexing foot 264 with a front support 110a. Specifically, FIG. 61 illustrates the threading of peg foot 272 into foot adapter 134. When fully threaded into foot adapter 134, peg foot 272 protrudes from the bottom surface of front support 110a. A manufacturer would likely install peg foot 272 before shipment to an end-user. However, an end-user can remove peg foot 272 by threadingly disengaging it from foot adapter 134. A manufacturer would also press ring 274 into the bottom surface of front support 110a. It should be noted that this process can be completed on any rear support, front support, left support, or right support of the present disclosure. For example, while described in conjunction with the front and rear supports relative to the right support, it will be appreciated that a similar configuration may be provided relative to the left support.

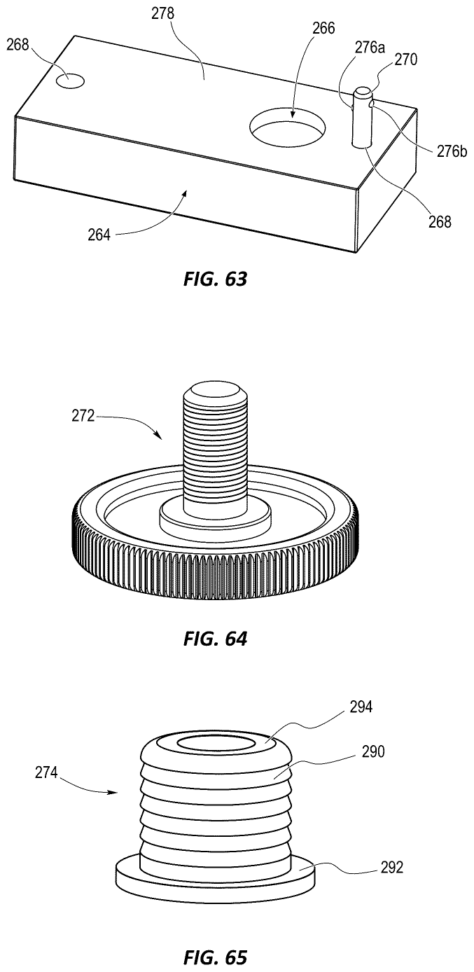

FIG. 62 illustrates the coupling of indexing foot 264. A user presses peg 270 into ring 274 while also inserting peg foot 272 into receiver 266 (see FIG. 63). By inserting both peg foot 272 into receiver 266 and peg 270 into ring 274, indexing foot 264 is secured into a specific orientation, preventing it from rotating or spinning out of place. A user can also decouple indexing foot 264 from front support 110a by pulling indexing foot 264 and front support 110a apart.

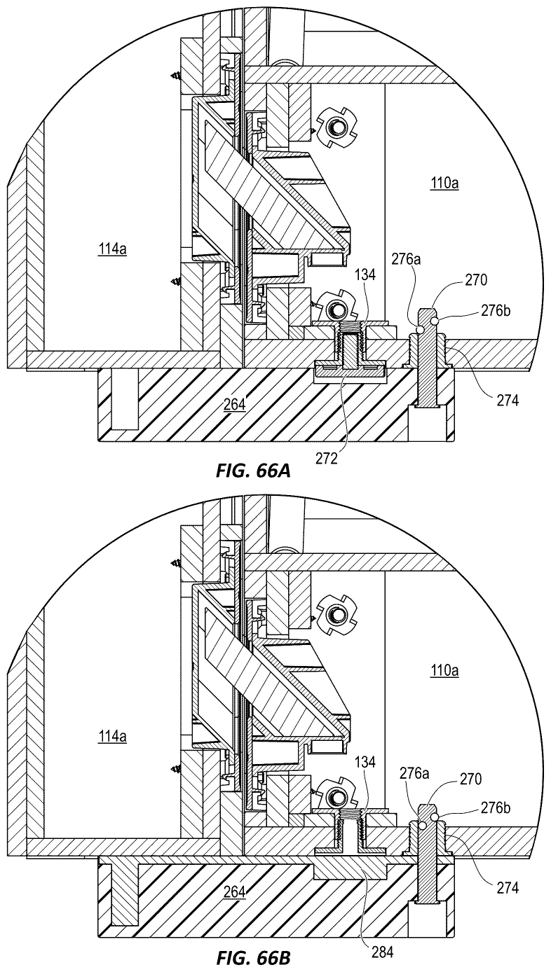

FIG. 63 illustrates indexing foot 264. Indexing foot 264 has one or more apertures 268, peg 270, receiver 266, and support surface 278. Each aperture 268 receives a corresponding peg 270. As illustrated, a manufacturer has only pressed one peg 270 into one of the apertures 268. During shipping, a manufacturer can nest two indexing feet 264 together by inserting the pegs 270 into the corresponding open aperture 268 of another indexing foot 264. As previously discussed, receiver 266 is configured to receive a portion of peg foot 272. Peg 270 includes one or more spring detents 276a and 276b. Spring detents 276a and 276b are embedded at different positions along the length of peg 272. As illustrated, spring detent 276b is farther along the length of peg 270 relative to support surface 278 than spring detent 276a. In other words, spring detent 276b is distal to spring detent 276a. A manufacturer can selectively choose the position of the spring detents to allow the spring detents to couple with a ring at different lengths. See FIGS. 66A and 66B for further information explaining the coupling at different lengths. Spring detents 276a and 276b are rounded to allow for the selective insertion and removal of peg 270 from a ring 274.

In another embodiment of indexing foot 264, a manufacturer can install a polygonal peg (e.g., a triangle, square, or other locking geometry) in place of illustrated cylindrical peg 270. In such an embodiment, the polygonal peg can act as an indexing peg to prevent the rotation of indexing foot 264 relative to either the front support, rear support, left support, or right support without the assistance of a peg foot 272. Similar anti-rotation locking can be accomplished without peg 270 by simply providing a peg foot 272 that has a geometry (e.g., a triangle, square, or other locking geometry) that locks within recess 266 provided with a complementary locking geometry.

FIG. 64 illustrates peg foot 272. Peg foot 272 includes a base and a threaded member. The base is received by receiver 266 of an indexing foot of the present disclosure (see FIG. 66A). The threaded member engages with foot adapters of the present disclosure.

FIG. 65 illustrates ring 274 of the present disclosure. Ring 274 is constructed from a rigid or semi-rigid material with high durability (e.g., nylon, other polyamide, or other suitable material). Ring 274 engages with the spring detents of peg 270. Ring 274 includes one or more flanges 290, a flared base 292, and an inner edge 294. Flanges 290 are illustrated as spanning the entire outer circumference of the ring 274. Flanges 290 are configured to frictionally engage with an aperture defined by the bottom surface of a rear support, front support, left support, or right support. When installed, flanges 290 compress inward, causing the 274 ring to stay in place and not easily be removed. In at least one embodiment, a manufacturer includes an adhesive between ring 274 and the aperture in which the ring is installed. A manufacturer will appreciate that producing rings of consistent dimensions is much simpler than ensuring every bottom surface of a rear support, front support, or side support has a consistent thickness. Accordingly, a manufacturer will appreciate the inclusion of ring 274 for coupling with peg 270 as it allows a manufacturer to ensure that the coupling of an indexing foot 264 is consistent for every modular furniture assembly in a cost-effective manner.

FIGS. 66A and 66B illustrate a cross-sectional view of an indexing foot 264 coupled with front support 110a. Specifically, FIG. 66A illustrates indexing foot 264 flush against front support 110a. As illustrated, spring detent 276a couples with an edge of ring 274, coupling indexing foot 264 with front support 110a.

FIG. 66B illustrates a bracket 284 inserted between indexing foot 264 and front support 110a. As previously discussed, peg 270 has spring detent 276a and 276b. In this embodiment, because spring detent 276b is embedded farther along the length of peg 270, spring detent 276b can still couple with the edge of ring 274, while spring detent 276a is inside ring 274. Bracket 284 can support electronics, accessories, or components of a modular furniture system. In at least one embodiment, a peg foot 272 can be installed and a corresponding receiver can be present on bracket 284.

The following are certain example embodiments of the invention.

### Embodiment 1

A modular furniture system comprising: a rear support; a front support; a left support; a right support; a plurality of pins; and one or more indexing feet configured to selectively couple to at least one of the front support or the rear support, wherein the rear support, front support, left support, and right support are selectively coupled together by the plurality of pins in order to form a rectangular modular furniture system.

### Embodiment 2

The modular furniture system of embodiment 1, wherein each of the one or more indexing feet comprises a peg having a length and one or more spring detents.

### Embodiment 3

The modular furniture system of embodiment 1-2, wherein the front support has one or more rings pressed into a bottom surface thereof, wherein a first ring is configured to receive a portion of a first peg of a first indexing foot of one of the one or more indexing feet.

### Embodiment 4

The modular furniture system of embodiment 1-3, wherein a first spring detent of the one or more spring detents of the first peg engages with a first edge of the ring.

### Embodiment 5

The modular furniture system of embodiment 1-4, wherein a second spring detent of one or more spring detents of the first peg engages with a first edge of the ring, and wherein the second spring detent is embedded into the first peg at a position farther along the length of the first peg relative to the support surface.

### Embodiment 6

The modular furniture system of embodiment 1-5, wherein a bracket is secured between the first indexing foot and the front support by the first peg.

### Embodiment 7

The modular furniture system of embodiment 1-6, wherein the modular furniture system further comprises a peg foot threadingly engaged with a foot adapter embedded into the bottom surface of the front support.

### Embodiment 8

The modular furniture system of embodiment 1-7, wherein the peg foot has a base that is received into a receiver defined by a support surface of the first indexing foot.

### Embodiment 9

The modular furniture system of embodiment 1-8, wherein the peg foot prevents the indexing foot from rotating about a longitudinal axis of the first peg.

### Embodiment 10

The modular furniture system of embodiment 1-9, wherein the first indexing foot further comprises a support surface configured to abut a bottom surface of either the left support or a bottom surface of the right support.

### Embodiment 11

The modular furniture system of embodiment 1-10, wherein the first ring has one or more flanges configured to frictionally secure the first ring into an aperture defined by the bottom surface of the front support.

### Embodiment 12

The modular furniture system of embodiment 1-11, wherein no portion of the one or more indexing feet extends into an internal space defined by the left support or the right support.

### Embodiment 13

A modular furniture system comprising: a rear support; a front support; a left support; a right support; a plurality of pins; and one or more indexing feet, each of the one or more indexing feet configured to selectively couple to the left support and/or to the right support; wherein the rear support and front support are selectively suspended between the left support and right support by the plurality of pins in order to form a rectangular modular furniture system.

### Embodiment 14

The modular furniture system of embodiment 13, wherein a first indexing foot of the one or more indexing feet comprises a support surface configured to abut a bottom surface of the front support.

### Embodiment 15

The modular furniture system of embodiment 13-14, wherein the first indexing foot comprises a first peg having a length and one or more spring detents.

### Embodiment 16

The modular furniture system of embodiment 13-15, wherein the right support has one or more rings secured into an aperture defined by a bottom surface, wherein a first ring is configured to receive a portion of the first peg of the first indexing foot.

### Embodiment 17

The modular furniture system of embodiment 13-16, wherein a first spring detent of the one or more spring detents of the first peg engages with a first edge of the ring.

### Embodiment 18

The modular furniture system of embodiment 13-17, further comprising a peg foot selectively threadingly engaged with a foot adapter embedded into the bottom surface of the right support.

### Embodiment 19

The modular furniture system of embodiment 13-18, wherein the peg foot has a base that is received into a receiver defined by a support surface of the first indexing foot, wherein the peg foot prevents the indexing foot from rotating about a longitudinal axis of the first peg.

### Embodiment 20

A modular furniture system comprising: a rear support; a front support; a left support; a right support; a plurality of pins; and one or more indexing feet, each of the one or more indexing feet configured to selectively couple to the front support and/or to the rear support; wherein the left support and right support are selectively suspended from opposing ends of the rear support and front support by the plurality of pins in order to form a rectangular modular furniture system.

All publications, patents, and patent applications cited herein, whether supra or infra, are hereby incorporated by reference in their entirety to the same extent as if each individual publication, patent, or patent application was specifically and individually indicated to be incorporated by reference.

As used herein, the term “between” includes any referenced endpoints. For example, “between 2 and 10” includes both 2 and 10.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used in the specification and appended claims, directional terms, such as “top,” “bottom,” “left,” “right,” “up,” “down,” and the like are used herein solely to indicate relative directions and are not otherwise intended to limit the scope of the disclosure or claims.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

We claim:

1. A modular furniture system comprising:
a rear support;
a front support;
a left support;
a right support;
a plurality of pins; and
one or more indexing feet configured to selectively couple to at least one of the front support or the rear support;
wherein the rear support, front support, left support, and right support are selectively coupled together by the plurality of pins in order to form a rectangular modular furniture system.

2. The modular furniture system of claim 1, wherein each of the one or more indexing feet comprises a peg having a length and one or more spring detents.

3. The modular furniture system of claim 2, wherein the front support has one or more rings pressed into a bottom surface thereof, wherein a first ring is configured to receive a portion of a first peg of a first indexing foot of one of the one or more indexing feet.

4. The modular furniture system of claim 3, wherein a first spring detent of the one or more spring detents of the first peg engages with a first edge of the ring.

5. The modular furniture system of claim 3, wherein a second spring detent of one or more spring detents of the first peg engages with a first edge of the ring, and wherein the second spring detent is embedded into the first peg at a position farther along the length of the first peg relative to the support surface.

6. The modular furniture system of claim 5, wherein a bracket is secured between the first indexing foot and the front support by the first peg.

7. The modular furniture system of claim 3, wherein the modular furniture system further comprises a peg foot threadingly engaged with a foot adapter embedded into the bottom surface of the front support.

8. The modular furniture system of claim 7, wherein the peg foot has a base that is received into a receiver defined by a support surface of the first indexing foot.

9. The modular furniture system of claim 8, wherein the peg foot prevents the indexing foot from rotating about a longitudinal axis of the first peg.

10. The modular furniture system of claim 3, wherein the first indexing foot further comprises a support surface configured to abut a bottom surface of either the left support or a bottom surface of the right support.

11. The modular furniture system of claim 3, wherein the first ring has one or more flanges configured to frictionally secure the first ring into an aperture defined by the bottom surface of the front support.

12. The modular furniture system of claim 1, wherein no portion of the one or more indexing feet extends into an internal space defined by the left support or the right support.

13. A modular furniture system comprising:
a rear support;
a front support;
a left support;
a right support;
a plurality of pins; and
one or more indexing feet, each of the one or more indexing feet configured to selectively couple to the left support and/or to the right support;
wherein the rear support and front support are selectively suspended between the left support and right support by the plurality of pins in order to form a rectangular modular furniture system.

14. The modular furniture system of claim 13, wherein a first indexing foot of the one or more indexing feet comprises a support surface configured to abut a bottom surface of the front support.

15. The modular furniture system of claim 14, wherein the first indexing foot comprises a first peg having a length and one or more spring detents.

16. The modular furniture system of claim 15, wherein the right support has one or more rings secured into an aperture defined by a bottom surface, wherein a first ring is configured to receive a portion of the first peg of the first indexing foot.

17. The modular furniture system of claim 16, wherein a first spring detent of the one or more spring detents of the first peg engages with a first edge of the ring.

18. The modular furniture system of claim 17, further comprising a peg foot selectively threadingly engaged with a foot adapter embedded into the bottom surface of the right support.

19. The modular furniture system of claim 18, wherein the peg foot has a base that is received into a receiver defined by a support surface of the first indexing foot, wherein the peg foot prevents the indexing foot from rotating about a longitudinal axis of the first peg.

20. A modular furniture system comprising:
a rear support;
a front support;
a left support;
a right support;
a plurality of pins; and
one or more indexing feet, each of the one or more indexing feet configured to selectively couple to the front support and/or to the rear support;
wherein the left support and right support are selectively suspended from opposing ends of the rear support and front support by the plurality of pins in order to form a rectangular modular furniture system.
